(19) United States
(12) Patent Application Publication
(10) Pub. No.: US 2025/0202695 A1
(43) Pub. Date: Jun. 19, 2025

(54) APPARATUS AND METHOD FOR DATA MANIPULATION DETECTION OR REPLAY PROTECTION

(71) Applicant: Intel Corporation, Santa Clara, CA (US)

(72) Inventors: Christoph DOBRAUNIG, St. Veit an der Glan (AT); David M. DURHAM, Beaverton, OR (US)

(21) Appl. No.: 18/545,752

(22) Filed: Dec. 19, 2023

(51) Int. Cl. H04L 9/08; G06F 12/0802

(52) U.S. Cl. CPC H04L 9/088; G06F 12/0802; G06F 2212/60

(57) ABSTRACT

An apparatus and method for data manipulation detection, alternate ciphertexts for the same plaintext or replay protection. For example, one implementation of a processor comprises: execution circuitry to execute instructions and generate memory access requests including load requests to read cachelines from memory and store requests to store cacheline to memory; and cryptographic circuitry to encrypt a cacheline and generate an encrypted cacheline responsive to a store request from a core of the plurality of cores, the cryptographic circuitry to map a subset of elements of the cacheline to corresponding elements in the encrypted cacheline and to encrypt the cacheline with a blockcipher encryption using a combination of a key and a tweak value.

### BACKGROUND

### Field of the Invention

This invention relates generally to the field of computer processors. More particularly, the invention relates to an apparatus and method for data manipulation detection or replay protection.

### Description of the Related Art

There exist many standardized and non-standardized encryption techniques that do not expand plaintexts. Examples include the cipher-block chaining (CBC) mode, wide (tweakable) blockciphers and other Advanced Encryption Standard (AES)-based encryption techniques as used, for example, in current Total Memory Encryption-Multi-Key (TME-MK) implementations. These solutions offer data confidentiality but do not provide non-repeating (ambiguous) ciphertexts, data manipulation detection or replay protection.

### BRIEF DESCRIPTION OF THE DRAWINGS

A better understanding of the present invention can be obtained from the following detailed description in conjunction with the following drawings, in which:

FIG. 1 illustrates a block diagram of a computer system including a processor, a memory controller circuit, and cryptographic circuitry according to examples of the disclosure.

FIG. 2 illustrates a format of a data line including a locator value for encoding a repeated value according to examples of the disclosure.

FIG. 3 illustrates the format of the data line from FIG. 2 including an additional locator bit used for the encoding of a repeated value according to examples of the disclosure.

FIG. 4 illustrates an example of operations for a method of performing a read from memory with repeated value encoding according to examples of the disclosure.

FIG. 5 illustrates an example of operations for a method of performing a write to memory with repeated value encoding according to examples of the disclosure.

FIG. 6 illustrates another example of operations for a method of performing a read from memory with repeated value encoding according to examples of the disclosure.

FIG. 7 illustrates an example computing system.

FIG. 8 illustrates a block diagram of an example processor and/or System on a Chip (SoC) that may have one or more cores and an integrated memory controller.

FIG. 9 is a block diagram illustrating a computing system 900 configured to implement one or more aspects of the examples described herein.

FIG. 10A illustrates examples of a parallel processor.

FIG. 10B illustrates examples of a block diagram of a partition unit.

FIG. 10C illustrates examples of a block diagram of a processing cluster within a parallel processing unit.

FIG. 10D illustrates examples of a graphics multiprocessor in which the graphics multiprocessor couples with the pipeline manager of the processing cluster.

FIGS. 11A-C illustrate additional graphics multiprocessors, according to examples.

FIG. 12 shows a parallel compute system 1200, according to some examples.

FIGS. 13A-13B illustrate a hybrid logical/physical view of a disaggregated parallel processor, according to examples described herein.

FIG. 14A is a block diagram illustrating both an example in-order pipeline and an example register renaming, out-of-order issue/execution pipeline according to examples.

FIG. 14B is a block diagram illustrating both an example in-order architecture core and an example register renaming, out-of-order issue/execution architecture core to be included in a processor according to examples.

FIG. 15 illustrates examples of execution unit(s) circuitry, such as execution unit(s) circuitry.

FIG. 16 is a block diagram of a register architecture according to some examples.

FIG. 17 illustrates examples of an instruction format.

FIG. 18 illustrates examples of an addressing information field.

FIG. 19 illustrates examples of a first prefix.

FIGS. 20A-20D illustrate examples of how the R. X, and B fields of the first prefix are used.

FIGS. 21A-21B illustrate examples of a second prefix.

FIG. 22 illustrates examples of a third prefix.

FIGS. 23A-23B illustrate thread execution logic including an array of processing elements employed in a graphics processor core according to examples described herein.

FIG. 24 illustrates an additional execution unit, according to an example.

FIG. 25 is a block diagram illustrating a graphics processor instruction formats according to some examples.

FIG. 26 is a block diagram of another example of a graphics processor.

FIG. 27A is a block diagram illustrating a graphics processor command format according to some examples.

FIG. 27B is a block diagram illustrating a graphics processor command sequence according to an example.

FIG. 28 is a block diagram illustrating the use of a software instruction converter to convert binary instructions in a source ISA to binary instructions in a target ISA according to examples.

FIG. 29 is a block diagram illustrating an IP core development system that may be used to manufacture an integrated circuit to perform operations according to some examples.

FIG. 30 illustrates an architecture including cryptographic circuitry in accordance with embodiments of the invention.

FIG. 31 illustrates a decryption method using conflict indicator values in accordance with embodiments of the invention.

FIG. 32 illustrates an encryption method using conflict indicator values in accordance with embodiments of the invention.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

The present disclosure relates to methods, apparatus, systems, and non-transitory computer-readable storage media for matching pair asymmetrical encryption in a computing system based on the higher probability of finding matching pairs according to the Birthday Problem. Examples herein are directed to memory controller circuitry and methods for data encryption that select between a set of matching tuples (e.g., pairs or triples of bytes with the same value) to be encoded to create different ciphertexts across encryptions of the same input plaintext. This confounds adversaries that expect to see the same ciphertext given the same plaintext when encrypted with symmetric ciphers. Furthermore, the examples herein detect ciphertext corruption and prevent software replay attacks. Examples herein are directed to a novel data encryption mode that select from a set of matching pairs (e.g., within birthday bounds) that are encoded to create different ciphertexts across encryptions of the same input plaintext, for example, where the novel data encryption mode is in addition to or alternatively to an XOR-encrypt-XOR (XEX) Tweakable block ciphertext Stealing (XTS) mode, Electronic Code Book (ECB) mode, Cipher Block Chaining (CBC) mode, etc. of the computer system (e.g., memory controller circuitry). Memory operations by a processor to external system memory may be protected via encryption and integrity, e.g., with integrity using additional metadata for storing integrity tags.

In certain examples, a processor includes an AES-XTS mode (e.g., XEX-based tweaked-codebook mode with ciphertext stealing) for memory encryption, e.g., including Intel® Total Memory Encryption (TME), Intel® Software Guard Extensions, and Intel® Trust Domain Extensions (TDX), and other storage encryption solutions. In certain examples, encryption in XTS mode uses the memory address as a tweak to create different ciphertext for different memory locations despite the input data being the same, whereas certain examples in ECB mode produce the same ciphertext for the same plaintext. However, a technical issue is that the same plaintext for the same address encrypted with the same key will still yield the same ciphertext, e.g., allowing an adversary (e.g., attacker) to use this symmetry to attempt to circumvent the encryption.

In certain examples, memory controller circuitry (e.g., a memory encryption engine) uses an in-memory version tree to give a unique counter value for every data encryption when storing data to memory. This results in a unique ciphertext for each write, but the version tree takes about twenty-five percent of memory for metadata and lowers performance by about three times. The high memory overheads and performance impact prevent real world use of such examples.

To overcome the above technical problems, examples herein take advantage of the seemingly paradoxical high probability of finding a matching pair of values in a set of random of matching values (e.g., bytes) in a cache line and/or memory line are used to break symmetries, e.g., even when using a symmetric cipher. In certain examples, when multiple pairs arise, (e.g., only) one pair is chosen to be encoded within a memory line or portion thereof. In certain examples, the pair to be encoded is chosen at random to change the resulting ciphertext, e.g., even when the input plaintext is the same. While many pairs are typical in non-random appearing computer data (for example, unencrypted and/or uncompressed data, such as, but not limited to, code, pictures, text files, memory initialized to zero, etc.) creating a large number of choices for an encoded (e.g., byte) pair, pairs also appear in random data (e.g., already encrypted data and/or compressed data). In certain examples, these choices allow for different encodings resulting in different ciphertexts across repeated encryptions of the same plaintext. In certain examples, rule(s) are applied to detect when the wrong pair was encoded, e.g., providing integrity or authenticity. In certain examples, a matching pair mode (e.g., “birthday pair” mode) of data encryption provides integrity, replay prevention, and/or ciphertext differentiation, for example, in contrast to an (e.g., XTS) mode does not provide integrity, replay prevention, and/or ciphertext differentiation and thus allowing adversarial code books to be generated or ciphertext corruption to go undetected. In certain examples, a processor (e.g., memory controller circuit) with a matching pair mode (e.g., “birthday pair” mode) of data encryption disclosed herein provides a more secure encryption, against even hardware adversaries, with the best performance and lowest cost. In certain examples, a physical circuit (e.g., memory controller circuit) for memory encryption (e.g., and decryption) includes a matching pair mode (e.g., “birthday pair” mode) of data encryption disclosed herein. In certain examples, a memory controller circuit in matching pair mode (e.g., “birthday pair” mode) of data encryption writing the same data to memory will result in different ciphertexts (e.g., with high probability). In certain examples, a memory controller circuit in matching pair mode (e.g., “birthday pair” mode) of data encryption is able to encrypt (e.g., encode) greater than about 98% of memory lines, e.g., and even about 70% of random data can be encoded, for example, virtually eliminating sequestered storage and accesses thereto, providing lower (e.g., XTS like) overhead and performance with much better security properties by constantly changing the ciphertext. A memory controller circuit (e.g., operating according to a matching pair mode disclosed herein) cannot practically be performed in the human mind (or with pen and paper).

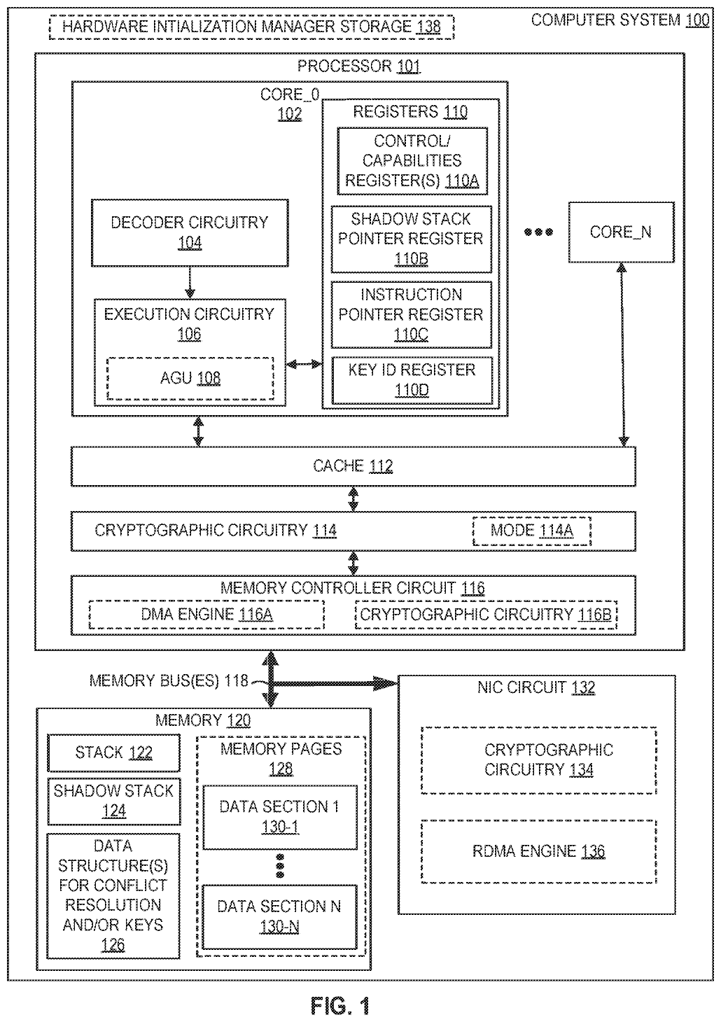

Turning now to the figures, FIG. 1 illustrates a block diagram of a computer system 100 including a processor 101, a memory controller circuit 116, and cryptographic circuitry (e.g., cryptographic circuitry 114, cryptographic circuitry 116B, and/or cryptographic circuitry 134) according to examples of the disclosure.

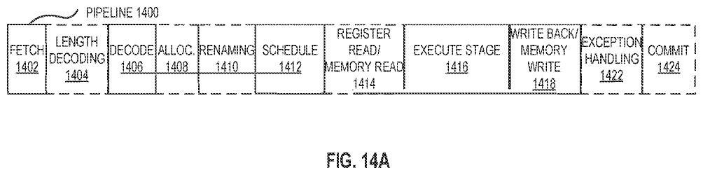

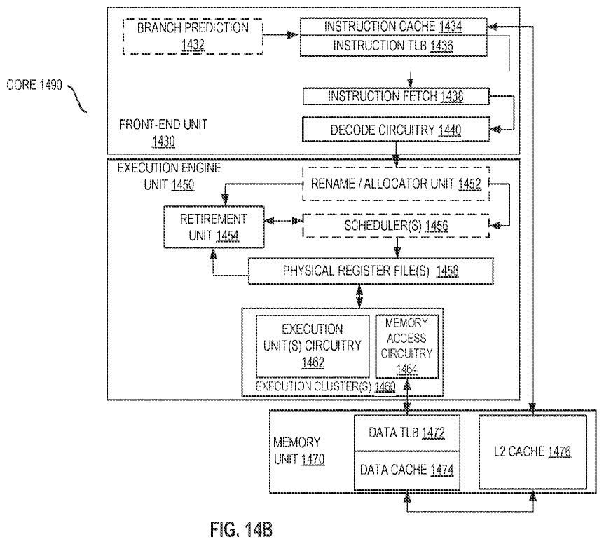

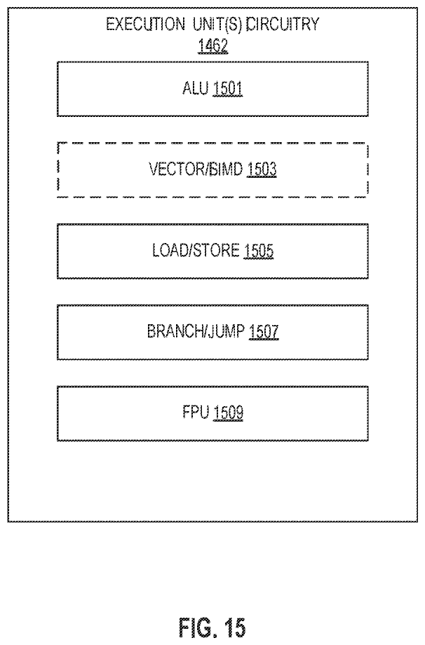

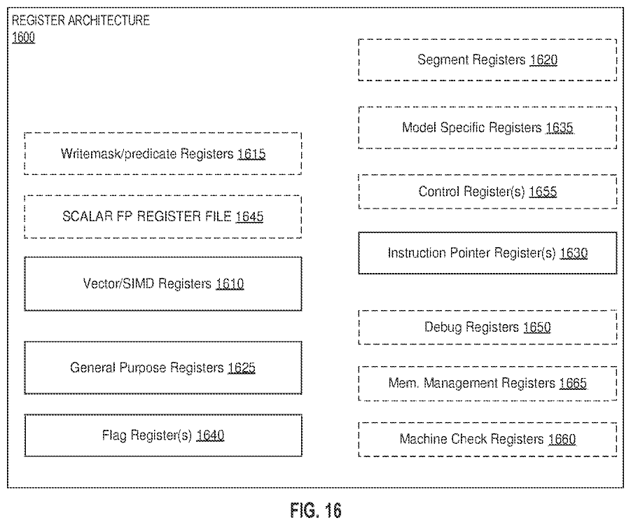

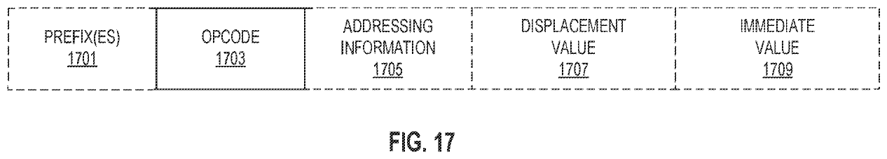

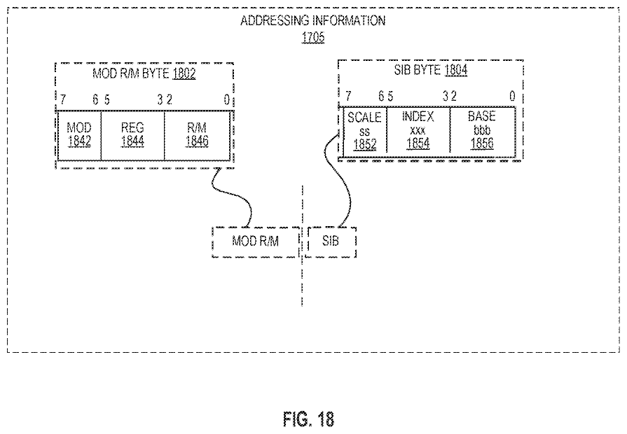

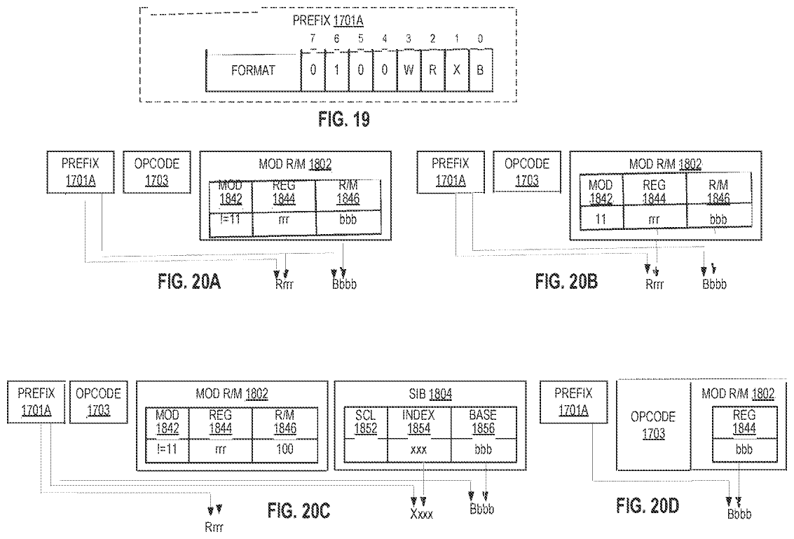

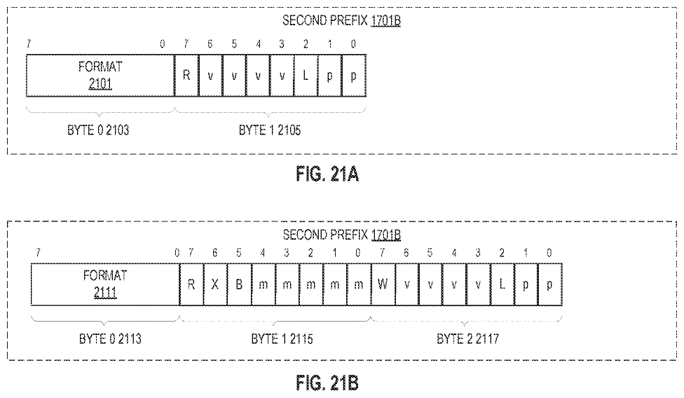

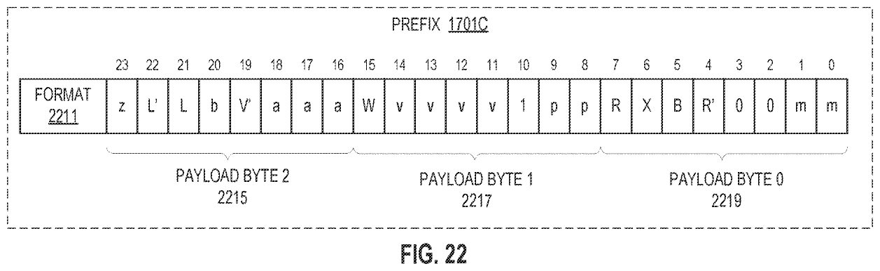

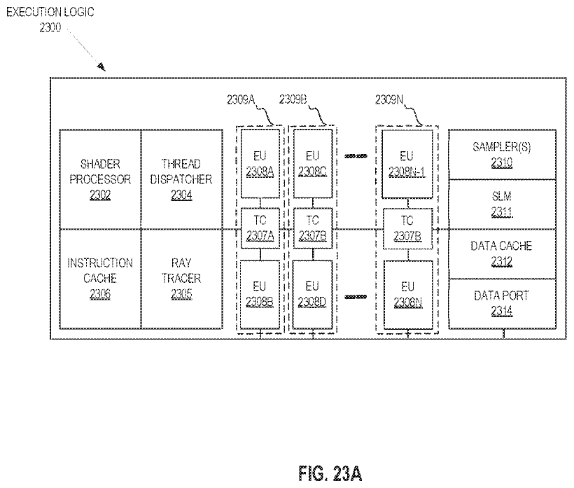

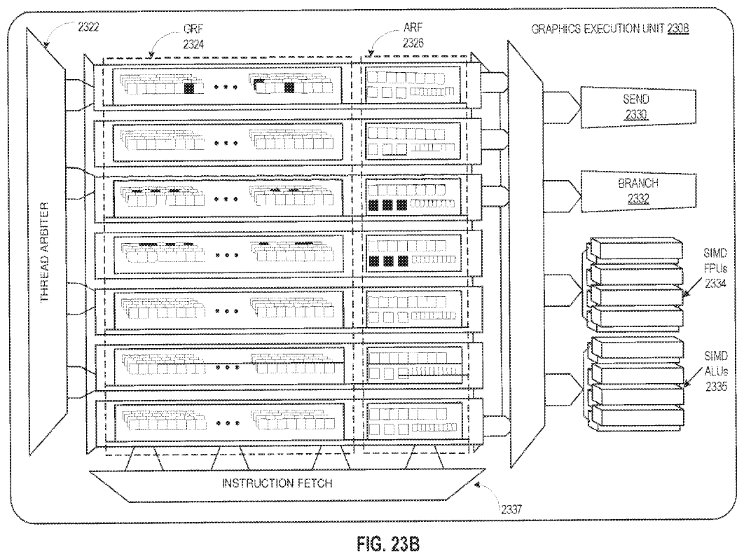

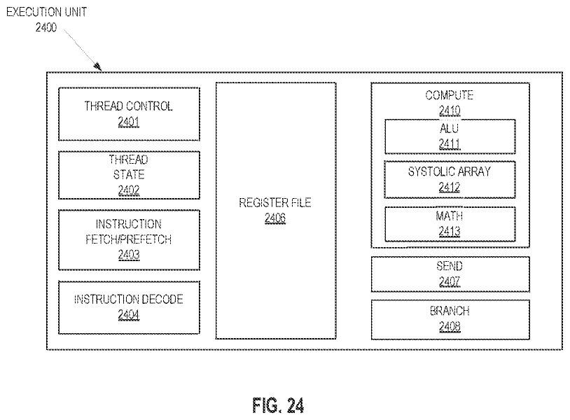

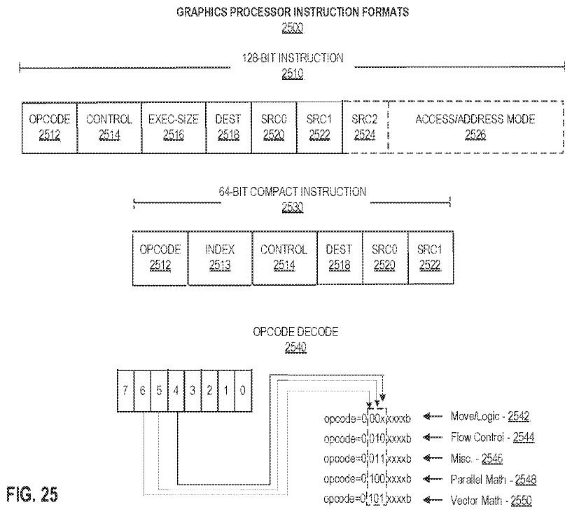

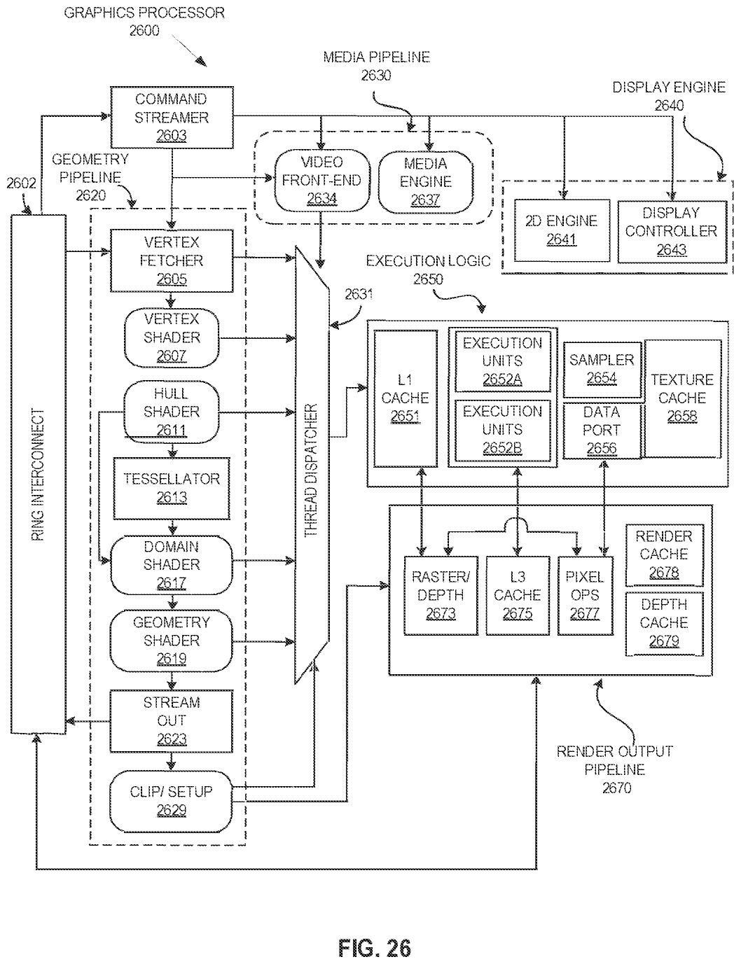

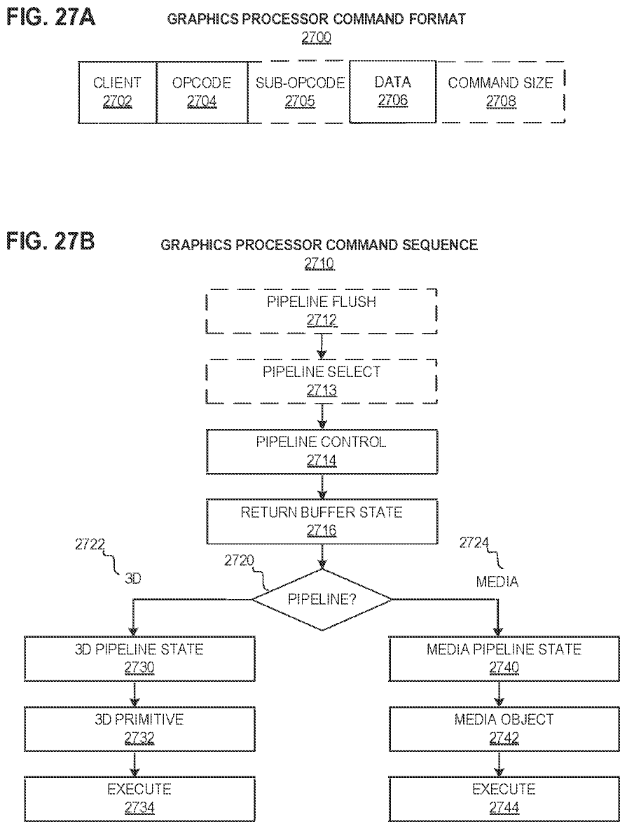

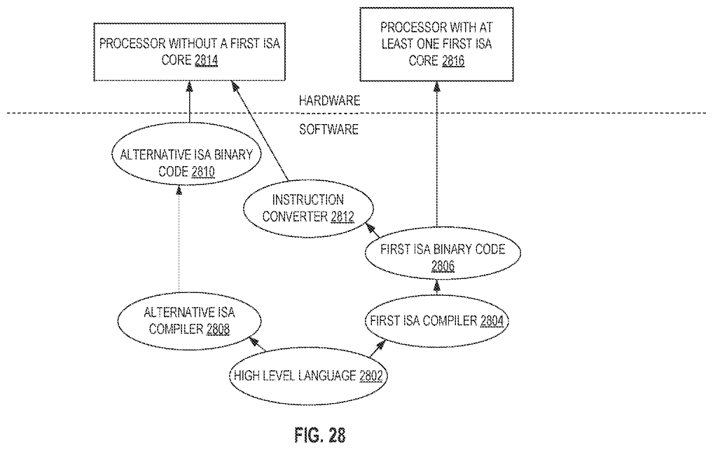

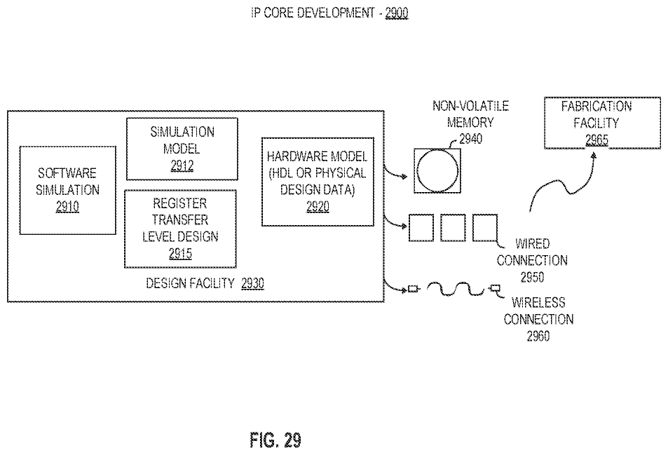

A core may be any hardware processor core, e.g., as an instance of core 1490 in FIG. 14B. Although multiple cores are shown, processor 101 may have a single or any plurality of cores (e.g., where N is any positive integer greater than 1).

Computer system 100 includes registers 110. In certain examples, registers 110 (e.g., for a particular core) includes one or any combination of: control/capabilities register(s) 110A, shadow stack pointer register 110B, instruction pointer (IP) register 1 IOC, and/or key identification (key ID) register 110D.

In certain examples, each of control/capabilities register(s) 110A of core 102 includes the same data as corresponding control/capabilities register(s) of other cores (e.g., core_N). In certain examples, control/capabilities registers store the control values and/or capability indicating values for cryptographic circuitry (e.g., an encryption circuit and/or decryption circuit) or other component(s). For example, where capabilities register(s) store value(s) (e.g., provided by execution of hardware initialization manager storage 138) that indicate the functionality that a corresponding cryptographic circuitry (e.g., cryptographic circuitry 114, cryptographic circuitry 116B, and/or cryptographic circuitry 134) is capable of and/or control register(s) store values that control the corresponding cryptographic circuitry (e.g., cryptographic circuitry 114, cryptographic circuitry 116B, and/or cryptographic circuitry 134).

In certain examples, memory 120 is to store a (e.g., data) stack 122 and/or a shadow stack 124. In certain examples, shadow stack 124 stores a context for a thread, for example, that includes a shadow stack pointer, e.g., for that context. Shadow stack pointer may be an address, e.g., a linear address or other value to indicate a value of the stack pointer. In certain examples, each respective linear address specifies a different byte in memory (e.g., in a stack). In certain examples, the current shadow stack pointer is stored in a shadow stack pointer register 110B.

In certain examples, a (e.g., user level) request (e.g., from a thread that is a user level privilege thread) to switch a context (e.g., push and/or pop a stack pointer) may be received. In certain examples, a request to switch a context includes pushing or popping from stack 122 one or more other items of data in addition to a stack pointer. In certain examples, program code (e.g., software) executing in user level may request a push or a pop of a (e.g., non-shadow) stack 122. In certain examples, a request is the issuance of an instruction to a processor for decode and/or execution. For example, a request for a pop of a stack pointer from stack 122 may include executing a restore stack pointer instruction. For example, a request for a push of a stack pointer to stack 122 may include executing a save stack pointer instruction. In certain examples, shadow stack 124 is a second separate stack that “shadows” the (e.g., program call) stack 122. In certain

In certain examples, a function loads the return address from both the call stack 122 and the shadow stack 124, e.g., and the processor 101 compares them, and if the two records of the return address differ, then an attack is detected (e.g., and an exception reported to the OS), and if they match, the access (e.g., push or pop) is allowed to proceed.

In certain examples, instruction pointer (IP) register 110C is to store the (e.g., current) IP value, e.g., RIP value for 64 bit address modes or EIP value for 32 bit addressing modes.

In certain examples, memory access (e.g., store or load) requests for memory 120 are generated by processor 101 (e.g., a core), e.g., a memory access request generated by execution circuitry 106 of core 102 (e.g., caused by the execution of an instruction decoded by decoder circuitry 104) and/or a memory access request may be generated by execution circuit of another core_N. In certain examples, a memory address for the memory access is generated by an address generation unit (AGU) 108 of the execution circuitry 106.

In certain examples, a memory access request is serviced by a cache, e.g., cache within a core and/or cache 112 shared by multiple cores. Additionally or alternatively (e.g., for a cache miss), memory access request may be serviced by memory 120 separate from a cache. In certain examples, a memory access request is a load of data from memory 120 into a cache of a processor, e.g., cache 112. In certain examples, a memory access request is a store of data to memory 120 from (e.g., a cache of) a processor, e.g., cache 112.

In certain examples, computer system 100 includes cryptographic circuitry (e.g., that utilizes encryption to store encrypted information and decryption to decrypt that stored and encrypted information). In certain examples, cryptographic circuitry is included within a processor 101. In certain examples, cryptographic circuitry 116B is included within memory controller circuit 116. In certain examples, cryptographic circuitry is included between levels of a cache hierarchy. In certain examples, cryptographic circuitry 134 is included within a network interface controller (NIC) circuit 132, e.g., a NIC circuit 132 that is to control the sending and/or receiving of data over a network. In certain examples, single cryptographic circuitry is utilized for both (e.g., all) cores of computer system 100. In certain examples, cryptographic circuitry includes a control to set it into a particular mode, for example, mode 114A to set cryptographic circuitry 114 into a particular mode (e.g., such as a matching pair mode (e.g., “birthday pair” mode) of data encryption and/or decryption discussed herein) or similarly for other cryptographic circuitry.

Certain systems (e.g., processors) utilize encryption and decryption of data to provide security. In certain examples, cryptographic circuitry is separate from a processor core, for example, as an offload circuit controlled by a command sent from processor core, e.g., cryptographic circuitry 114 separate from any cores. Cryptographic circuitry 114 may receive a memory access (e.g., store) request from one or more of its cores (e.g., from address generation unit 108 of execution circuitry 106). In certain examples, cryptographic circuitry is to, e.g., for an input of a destination address and text to be encrypted (e.g., plaintext) (e.g., and a key), perform an encryption to generate a ciphertext (e.g., encrypted data). The ciphertext may then be stored in storage, e.g., in memory 120. In certain examples, cryptographic circuitry performs a decryption operation, e.g., for a memory load request. The cryptographic circuitry may include a tweaked mode of operation, such as AES-XTS, using the memory address as a tweak to the cryptographic operation, e.g., ensuring that even the same data encrypted for different addresses results in different ciphertext. Other modes such as AES-CBC may be used to extend across an entire memory line that is larger than a single block of data, e.g., allowing an initial locator value for a pair encoding to be distributed across the ciphertext for an entire memory line.

In certain examples, a processor (e.g., as an instruction set architecture (ISA) extension) supports total memory encryption (TME) (for example, memory encryption with a single ephemeral key) and/or multiple-key TME (TME-MK or MKTME) (for example, memory encryption that supports the use of multiple keys for page granular memory encryption, e.g., with additional support for software provisioned keys).

In certain examples, TME provides the capability to encrypt the entirety of the physical memory of a system. For example, with this capability enabled in the very early stages of the boot process with a small change to hardware initialization manager code (e.g., Basic Input/Output System (BIOS) firmware), e.g., stored in storage 138. In certain examples, once TME is configured and locked in, it will encrypt all the data on external memory buses of computer system 100 using an encryption standard/algorithm (e.g., an Advanced Encryption Standard (AES), such as, but not limited to, one using 128-bit keys). In certain examples, the encryption key used for TME uses a hardware random number generator implemented in the computer system (e.g., processor), and the key(s) (e.g., to be stored in data structure 126) are not accessible by software or by using external interfaces to the computer system (e.g., system-on-a-chip (SoC)). In certain examples, TME capability provides protections of encryption to external memory buses and/or memory.

In certain examples, multi-key TME (TME-MK) adds support for multiple encryption keys. In certain examples, the computer system implementation supports a fixed number of encryption keys, and software can configure the computer system to use a subset of available keys. In certain examples, software manages the use of keys and can use each of the available keys for MK allow page granular encryption of memory where the physical address specifies the key ID (KeyID). In certain examples (e.g., by default), cryptographic circuitry (e.g., TME-MK) uses the (e.g., TME) encryption key unless explicitly specified by software. In addition to supporting a processor (e.g., central processing unit (CPU)) generated ephemeral key (e.g., not accessible by software or by using external interfaces to a computer system), examples of TME-MK also support software provided keys. In certain examples, software provided keys are used with non-volatile memory or when combined with attestation mechanisms and/or used with key provisioning services. In certain examples, a tweak key used for TME-MK is supplied by software. Certain examples (e.g., platforms) herein use TME and/or TME-MK to prevent an attacker with physical access to the machine from reading memory (e.g., and stealing any confidential information therein). In one example, an AES-XTS standard is used as the encryption algorithm to provide the desired security.

In certain examples, each page of memory pages 128 includes a key used to encrypt information, e.g., and thus can be used to decrypt that encrypted information. In certain examples, the keyID register is used with page tables (e.g., extended and/or non-extended page tables). In certain examples, the keyID register specifies the key itself, e.g. where the cryptographic engine (e.g., cryptographic circuitry) is part of the processor pipeline. In certain examples, the keyID register provides the keyID, e.g., the page table entries do not provide the keyID.

In certain examples, TME-MK cryptographic (e.g., encryption) circuitry maintains an internal key table not accessible by software to store the information (e.g., key and encryption mode) associated with each KeyID (e.g., a corresponding KeyID for a corresponding encrypted memory block/page) (for example, where a key ID is incorporated into the physical address, e.g., in the page tables, and also in every other storage location such as the caches and TLB). In one example, each KeyID is associated with one of three encryption modes: (i) encryption using the key specified, (ii) do not encrypt at all (e.g., memory will be plain text), or (iii) encrypt using the TME Key. In certain examples, unless otherwise specified by software, TME (e.g., TME-MK) uses a hardware-generated ephemeral key by default which is inaccessible by software or external interfaces, e.g., and TME-MK also supports software-provided keys.

In certain examples, the PCONFIG is used to program KeyID attributes for TME-MK.

Table 1 below indicates an example TME-MK Key Table:

| KeyID | Key | Encryption Mode |
|---|---|---|
| (entry 1) | (entry 1) | (entry 1) |
| (entry 2) | (entry 2) | (entry 2) |

| Leaf | Encoding | Description |
|---|---|---|
| TME- | 0x00000000 | This leaf is used to program |
| MK_KEY_PROGRAM | | the key and encryption mode |
| | | associated with a KeyID. |
| RESERVED | 0x00000001- | Reserved for future use |
| | 0xFFFFFFFF | (#GP(0) if used). |

Table 3 below indicates example PCONFIG targets (e.g., TME-MK encryption circuit):

| Target Identifier | Value | Description |
|---|---|---|
| INVALID_TARGET | 0x00000000 | Invalid target identifier |
| TME-MK | 0x0000000I | Multi-Key Total Memory |
| | | Encryption Engine |
| RESERVED | 0x00000002- | Reserved for future use. |
| | 0xFFFFFFFF | |

In a virtualization scenario, certain examples herein allow a virtual machine monitor (VMM) or hypervisor to manage the use of keys to transparently support (e.g., legacy) operating systems without any changes (e.g., such that TME-MK can also be viewed as TME virtualization in such a deployment scenario). In certain examples, an operating system (OS) is enabled to take additional advantage of TME-MK capability, both in native and virtualized environments. In certain examples, TME-MK is available to each guest OS in a virtualized environment, and the guest OS can take advantage of TME-MK in the same ways as a native OS.

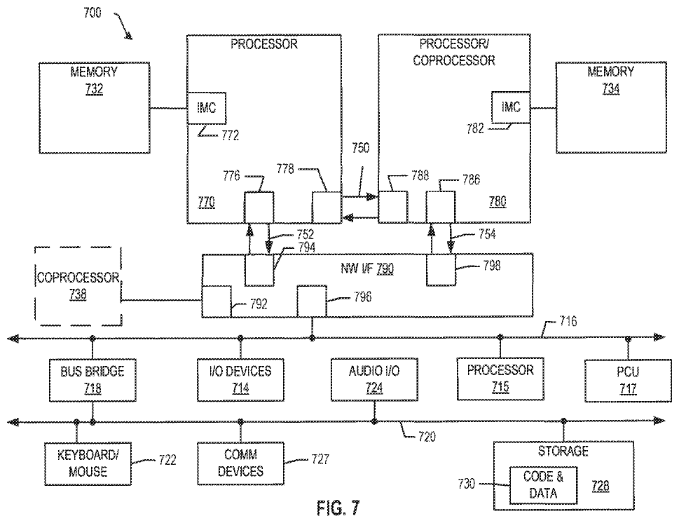

In certain examples, computer system 100 includes a memory controller circuit 116. In one example, a single memory controller circuit is utilized for a plurality of cores of computer system 100. Memory controller circuit 116 of processor 101 may receive an address for a memory access request, e.g., and for a store request also receiving the payload data (e.g., ciphertext) to be stored at the address, and then perform the corresponding access into memory 120, e.g., via one or more memory buses 118. Each memory controller (MC) may have an identification value, e.g., “MC ID”. Memory and/or memory bus(es) (e.g., a memory channel thereof) may have an identification value, e.g., “channel ID”. Each memory device (e.g., non-volatile memory 120 device) may have its own channel ID. Each processor (e.g., socket) (e.g., of a single SoC) may have an identification value, e.g., “socket ID”. In certain examples, memory controller circuit 116 includes a direct memory access engine 116A, e.g., for performing memory accesses into memory 120. Memory may be a volatile memory (e.g., DRAM), non-volatile memory (e.g., non-volatile DIMM or non-volatile DRAM) and/or secondary (e.g., external) memory (e.g., not directly accessible by a processor), for example, a disk and/or solid-state drive (e.g., memory unit 728 in FIG. 7). In certain examples, memory controller circuit 116 is to perform compression and/or decompression of data, e.g., where multiple bits (e.g., one or more bytes) of data that are repeated in a data line are removed to allow for compression according to that repetition (e.g., repetition-based compression/decompression).

In certain examples, computer system 100 includes a NIC circuit 132, e.g., to transfer data over a network. In certain examples, a NIC circuit 132 includes cryptographic circuitry 134 (e.g., encryption and/or decryption circuit), e.g., to encrypt (and/or decrypt) data, but without a core and/or encryption (or decryption) circuit of a processor (e.g., processor die) performing the encryption (or decryption). In the case where a NIC circuit that is supplied by a different vendor (e.g., manufacturer) than a socket (e.g., processor), the NIC circuit is viewed as a security risk for the vendor (e.g., manufacturer) of the socket in certain examples. In certain examples, encryption (and decryption) performed by NIC circuit 132 is enabled or disabled (e.g., via a request sent by socket). In certain examples, NIC circuit 132 includes a remote DMA engine 136, e.g., to send data via a network.

In one example, the hardware initialization manager (non-transitory) storage 138 stores hardware initialization manager firmware (e.g., or software). In one example, the hardware initialization manager (non-transitory) storage 138 stores Basic Input/Output System (BIOS) firmware. In another example, the hardware initialization manager (non-transitory) storage 138 stores Unified Extensible Firmware Interface (UEFI) firmware. In certain examples (e.g., triggered by the power-on or reboot of a processor), computer system 100 (e.g., core 102) executes the hardware initialization manager firmware (e.g., or software) stored in hardware initialization manager (non-transitory) storage 138 to initialize the system 100 for operation, for example, to begin executing an operating system (OS) and/or initialize and test the (e.g., hardware) components of system 100.

In certain examples, data is stored as a single unit in memory 120, e.g., a first data section 130-1 stored on a first memory page and a second data section 130-N (e.g., where N is any integer greater than 1) stored (e.g., at least in part) on a second memory page.

In certain examples, a computer system (e.g., memory controller circuit thereof) implements a matching pair mode (e.g., “birthday pair” mode) of data encryption and/or decryption. The below examples (e.g., modes or sub-modes) refer to a cache line width of data memory line) may be utilized. In some examples, a cache line or memory line may be larger or smaller. Certain examples herein modify the input plaintext according to one or more of the examples (e.g., modes or sub-modes) herein to generate a modified plaintext. Certain examples herein use circuitry in a birthday mode to modify a same input plaintext differently (e.g., when that same plaintext is to be encoded) to generate a different output (e.g., ciphertext) in multiple encryptions of that same input plaintext. In certain examples, a locator value (e.g., 8 bits/1 Byte wide) is used within the data line (e.g., cache line), for example, not within separate metadata or additional memory. In certain examples, a locator value (e.g., 8 bits/1 Byte wide) is to (i) identify a location of the repeated value that is still within the modified plaintext (e.g., the modified plaintext that includes the locator value) and (ii) identify a location of the repeated value that is not within the modified plaintext to make space for the locator value.

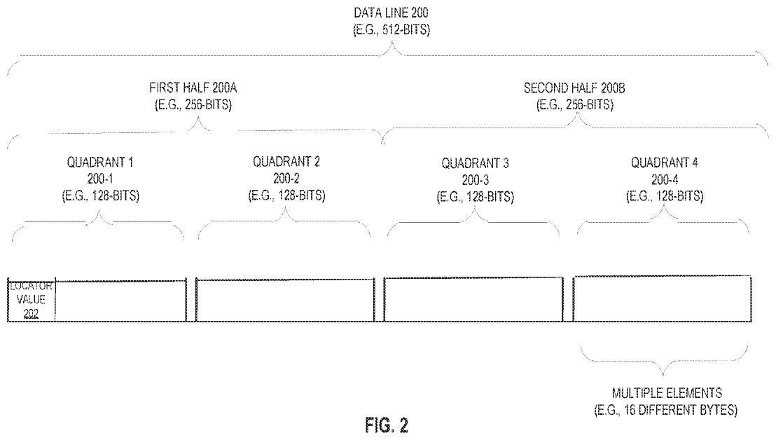

FIG. 2 illustrates a format of a data line 200 including a locator value 202 for encoding a repeated value according to examples of the disclosure. Although the locator value is shown at the beginning of the first (e.g., leftmost) end of the data line 200, it should be understood that other locations may be used, e.g., where the mode indicates to the memory controller circuit where the locator value is to be located in a modified data line (e.g., modified cache line). In certain examples, the data line 200 (e.g., 512 bits) includes a first half 200A (e.g., upper 256 bits) and a second half 200B (e.g., lower 256 bits). In certain examples, the data line 200 (e.g., first half 200A) includes a first quadrant 200-1 (e.g., upper 128 bits of the first half 200A), a second quadrant 200-2 (e.g., lower 128 bits of the first half 200A), a third quadrant 200-3 (e.g., upper 128 bits of the second half 200B), and a fourth quadrant 200-4 (e.g., lower 128 bits of the second half 200B). Note that the quadrants are shown spaced apart to illustrate their boundaries, but it should be understood that all four quadrants are concatenated together within data line 200.

In certain examples, a data line 200 includes multiple elements (e.g., a 512-bit data line 200 including 64 elements where each element is 8 bits/1 Byte wide).

In certain examples, a memory controller circuit (e.g., memory controller circuit 116 in FIG. 1) is to receive a data line 200 (e.g., single cache line) for writing to the memory (e.g., memory 120), search the data line for a repeated value, determine that the repeated value in the data line is identifiable using a locator value 202 for a repeated value in the data line, in response to the determination, generate the locator value for the repeated value in the data line, remove a second instance of the repeated value from the data line and insert the locator value into the data line to generate a modified data line (e.g., modified plaintext), encrypt the modified data line (e.g., modified plaintext) into an encrypted data line, and cause a write of the encrypted data line to the

### Modes

In certain examples, one value of a repeated pair of values in a data line 200 is removed to make room (e.g., space) in the modified data line for the locator value. In certain examples, the format of the locator value is according to one or more of the examples (e.g., modes or sub-modes) herein to generate a modified data line (e.g., modified plaintext).

In certain examples, in a first mode (e.g., first sub-mode) (e.g., first algorithm), a certain number of (e.g., 16) bits of a data line (e.g., plaintext) are encoded, based on two sets of repeated values (e.g., bytes) (e.g., any “birthday pair”). In certain examples, those number of bits (e.g., 16 b/2 B) recovered (e.g., removed) is for a locator value. In certain examples, the locator value includes two bits to indicate first and second block locations (e.g., 16 B), e.g., first or second block (e.g., quadrant) indicated by a first bit set to 0 or 1 (e.g., respectively) of the locator value and third or fourth block (e.g., quadrant) indicated by a second bit set to 0 or 1 (e.g., respectively) of the locator value.

In certain examples, the locator value includes four bits location first in block and 3 bits of offset location of second byte in same block (e.g., can extend to wraparound or adjacent block, extending to adjacent block may give more options as these are all random bytes)

In certain examples, the locator value includes 4 bits and 3 bits for identifying bytes in second identified block (e.g., last block may wraparound to first).

In certain examples, if there are not two sets of valid repeated values (e.g., pairs that are encodable according to a format of the locator values), then set a first value of the locator value to indicate no encoding with an invalid (e.g., 16 b) locator value (e.g., xFFFF). In certain examples, a memory controller circuit uses an error correction code (ECC) to correct this replaced (e.g., 16 b) value as if it was corrupted data. In certain examples, the replaced original (e.g., byte) value may instead be stored in sequestered memory (e.g., data structure 126 for conflict resolution in FIG. 1) so that the memory line may be restored to its original value.

In certain examples, it is assumed that across all four blocks (e.g., quadrants), there are often more than 2 pairs of repeated values, e.g., even for random data (e.g., where approximately 40% of the time a byte value repeats within a quadrant). In certain examples, a memory controller circuit utilizes multiple sets of repeated values for asymmetrical encryption because on a write, the memory controller circuit (e.g., randomly) chooses a first set (e.g., first pair) of matching values for encoding, and leaves the second (or third, fourth, etc.) set of matching values for next choice, e.g., where this choice results in different/asymmetric ciphertext across writes in comparison to what was read. In certain examples, the modified data (e.g., modified plaintext) is encoded, e.g., based on the domain key to prevent controlled replay across domains by an adversary.

In certain examples, in a second mode (e.g., second sub-mode) (e.g., second algorithm), a data line (e.g., plaintext) (e.g., 64 bytes) is split into four equal sized quadrants (e.g., each of 128 b/16 B) and the memory controller circuit (e.g., encoding algorithm thereof) searches for the collision of values (e.g., on a single byte granularity) in the first quadrant with the second and a collision with one value (e.g., one byte) of the third quadrant with one value (e.g., one byte) of the fourth. In certain examples, the memory controller circuit is then to compress the data line by two bytes (16 bits), and is thus to use four times four bits to locate the matching bytes in the quadrants. In certain examples, the memory controller circuit is to find one matching pair on average for both bytes that encode (e.g., 16*16/2″8). In certain examples, one location value (e.g., 0xFFFF) is taken (e.g., reserved) to indicate that there were no found matching values and would not encode. In certain examples, the one location value is reclaimed as the locator position.

In certain examples, in a third mode (e.g., third sub-mode) (e.g., third algorithm), the memory controller circuit is only to encode one pair (e.g., one byte) in one half of a data line (e.g., plaintext) (e.g., 64 bytes), for example, in one mode, both the repeated values of a single pair are required to be in the same half of a data line (e.g., and the locator value is included in that half of the data line).

In certain examples, in a fourth mode (e.g., fourth sub-mode) (e.g., fourth algorithm), the memory controller circuit is to extend the one pair encoding of the third mode across the data line (e.g., 64 B cache line). In certain examples, for a single byte encoding (e.g., single byte locator value), having multiple pairs gives a choice on which pair to encode. This choice can also carry information when there are multiple alternate pairs available (e.g., encoding one pair but not knowing which half it is in, there are two possible locations). For example, always choose the highest byte value for the encoded pair in certain examples. That means, on a read, when the memory controller circuit determines there are multiple (e.g., unencoded) pairs, there are two alternative locations for the encoded byte, e.g., presuming that the correct alternate encoded location is the one with the larger byte value of the two possible locations. Certain examples herein chose to encode the pair with this property on a write. Examples herein further increase the efficiency of a single pair encoding to cover the whole data line (e.g., cache line) (e.g., to cover all four quadrants) when multiple pairs exist. In certain examples, the remaining unencoded pairs indicate to the memory controller circuit which encoded location (e.g., half) is the correct one.

In certain examples, for data not following a uniform distribution, it is assumed that the the probability distribution leading to the smallest number of collisions. In certain examples, if the data follows any other probability distribution, e.g., like the characters in English texts, it can be expected that many collisions to occur (e.g., the space character repeats frequently). This means that the fraction of cache lines that are encodable rises for non-random data, e.g., with 98% of lines being encodable according to the examples herein, minimizing the need to access a conflict table, and avoiding any associated performance impact.

In certain examples, the memory controller circuit determines that a data line 200 includes only one set of matching values (e.g., one pair) and they are both in the first half 200A of the data line. In certain examples, such an encode is achieved with an eight bit locator, e.g., such that the first five bits of the locator indicate which of 32 different bytes within the 256 bytes (e.g., 8 bits per slot×32 slots=256 bits) includes the first instance of the matching values that is still within the modified plaintext and the other three bits of the locator indicate an offset (e.g., a three bit offset) within that half (e.g., within that quadrant) of the second instance of the matching values that is removed (for example, to utilize, e.g., with shifting as discussed herein, that removed space to store the locator value 202). In certain examples, such a decode is achieved by the memory controller circuit because it detects no other pair, it uses an eight bit encode of the one pair in the first half only, e.g., and recreates the single pair in the first half using the locator value. In certain examples, a locator value is selected to indicate any split of bits for absolute or relative indexing, for example, an 8-bit locator value to cumulatively identify two different byte locations, e.g., (i) using five bits to identify a first byte and three bits to identify (e.g., an offset to) a second byte or (ii) using six bits to identify one out of 64 different bytes and two bits to identify (e.g., an offset to) a second byte (e.g., 2 bytes of relative offset to this byte).

In certain examples, the memory controller circuit determines that a data line 200 includes no matching values or only one set of matching values (e.g., one pair) and they are both in the second half 200B of the data line. In certain examples, such an encode is not achieved with an eight bit locator format, e.g., and the locator value field 202 indicates that the memory line address is to be used as an index into data structure 126 for conflict resolution in FIG. 1 to determine the data value of the original plaintext that was removed (e.g., in the same bit positions) (e.g., overwritten) by the locator value field 202 (e.g., index into data structure 126 stored in that field 202). In certain examples, such a decode is not achieved with the eight bit locator format, e.g., and the locator value field 202 is instead used to store a value that indicates no compression of the plaintext was performed, e.g., the value indicating that the memory line address being an index into data structure 126 for conflict resolution in FIG. 1 storing the data value of the original plaintext that is removed (e.g., in the same bit positions) (e.g., overwritten) by the locator/conflict value field 202 (e.g., index into data structure 126 stored in that field 202). In some examples, the locator conflict value is followed by an index into data structure 126 for conflict resolution, e.g., where the conflict value and index replace the original data now stored in the data structure 126 allowing the full memory line to be recovered while optimizing the memory usage for data structure 126.

In certain examples, the format of the pair encoding (e.g., and locator value) used for an encoding is the same as that used for a decoding, e.g., according to the mode.

### Additional Locator Bit(s)

In certain examples, an additional locator bit (e.g., 9th bit) is desired to be used, however, the removal of the single value (e.g., eight bits/byte) of a pair of repeated values only creates that amount (e.g., eight bits) of space in the modified data line (e.g., modified plain text). In certain examples, a memory controller circuit includes a mode that utilizes an additional locator bit.

In certain examples, when two or more pairs exist on a write, the additional locator bit (e.g., 9th bit) is used to deterministically locate the encoded pair by identifying which half it is located. In certain examples, the additional locator bit overlaps with more data, so the memory controller circuit is to reconstruct the original data according to a rule, for example, where the rule is if the original data bit was a one, then the largest or highest pair is encoded (e.g., larger value of the two pairs of repeated value or the pair is in the farthest/highest position from the beginning of the data line), else, the smallest or lowest pair is encoded (e.g. the smallest byte value or the pair closest to the beginning of the data line). In certain examples, if more than two pairs exist, then the encoded pair is in the top half for a one in that bit position (e.g., 9th bit) in the original data (e.g., unmodified data) versus the encoded pair in the bottom half for zero in that bit position (e.g., 9th bit) in the original data (e.g., unmodified data).

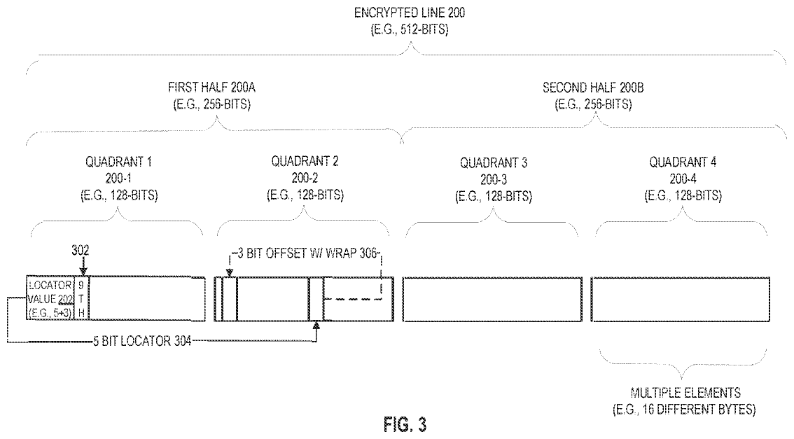

FIG. 3 illustrates the format of the data line 200 from FIG. 2 including an additional locator bit 302 conditionally used for the encoding of a repeated value according to examples of the disclosure. In certain examples, the additional locator bit 302 (e.g., the 9th bit) is adjacent to the locator value 202 (e.g., bits 1-8) of the modified data line (e.g., modified plaintext).

In certain examples, if multiple pairs of repeated values (e.g., a first pair having a repeated byte value of six and a second pair having a repeated byte value of zero in a pair), the additional locator bit 302 (e.g., ninth bit) determines which half of the data line (e.g., cache line) the encoded pair is located (e.g., otherwise assume single pair is in first half encoded with just an of locator value 202, which locate the repeated byte value, and a three-bit offset value 306 of the locator value 202, e.g., with wraparound within that quadrant to locate byte replaced by locator. This allows any one pair within any quadrant to be encoded.

In certain examples, a memory controller circuit (e.g., in an “additional locator bit” mode) determines that there are two pairs of matching values (e.g., a first pair with a first matching value and a second pair with a second matching value), so, as there are two or more pairs, it is to use the additional locator bit 302 (e.g., 9th bit). In certain examples, the reason two or more pairs are required to use the locator (e.g., 9th) bit is that the choice of which pair to encode is used to recover the data bit replaced by the ninth locator bit.

### Two (or More) Pairs in First Half (No Pair in Second Half)

In certain examples, on a memory write, if the original (e.g., ninth) data bit (e.g., in the data line at position 302) is a zero, the memory controller circuit is to encode the lowest pair (e.g., the pair at the lower relative position compared to the other pair), and if that pair is in the first half of the cache line 200A, the ninth bit 302 is set to zero, else the ninth bit 302 is set to one indicating the encoded pair is in the second half of the cache line 200B, and if the original data bit is a one, the memory controller circuit is to encode the highest pair (e.g., the pair at the higher relative position) and if that encoded pair is in the first half of the cache line 200A the ninth bit 302 is set to zero, else if the highest pair is in the second half of the cache line 200B, the ninth bit 302 is set to one. In this way, the ninth bit locates which half the encoded pair is, and the original data bit replaced by the ninth bit is determined by which pair (e.g. the higher or lower location) was encoded.

In certain examples, a decode of a modified data line (e.g., modified plaintext) using the additional locator value 302 includes the memory controller circuit determining if the modified data line includes an unencoded pair of values, (e.g. a visible pair of matching byte values within the same quadrant), and thus the memory controller circuit is to presume that the additional locator value 302 is used if so, allowing the encoded pair to be located across both halves of the cache line.

In certain examples, on decode, the additional locator value 302 being set to a zero indicates to the memory controller circuit that the pair of matching (e.g., repeated) values that is encoded by the locator value 202 is within the first half of the data line. In certain examples, the memory controller circuit determines that the pair encoded by the locator value 202 and ninth bit 302 is at a lower position versus the second (e.g., unencoded) pair, and sets the bit position formerly storing the additional locator value 302 to a zero, else sets the bit to a one, e.g., to generate the original plaintext (e.g., where the memory controller circuit is further to restore the data (e.g., byte) encoded by the locator value 202.

### Two (or More) Pairs in Second Half (and None in First Half)

In certain examples, if the original (e.g., ninth) data bit (e.g., in the data line) is a zero, the memory controller circuit is to encode the smallest pair (e.g., the pair at the lower relative position), and if that encoded pair is located in the second half, overwrites the data bit with one, and if the original data bit is a one, the memory controller circuit is to encode the highest pair (e.g., the pair at the higher relative position), and if that encoded pair is in the second half, overwrites the data bit with a one.

In certain examples, a decode of a modified data line (e.g., modified plaintext) using the additional locator value 302 includes the memory controller circuit determining if the modified data line includes an unencoded pair of values, (e.g. a visible pair of matching byte values within the same quadrant), and thus the memory controller circuit is to presume that the additional locator value 302 is used if so, allowing the encoded pair to be located across both halves of the cache line.

In certain examples, the additional locator value 302 being set to a one indicates to the memory controller circuit that the pair of matching (e.g., repeated) values that is encoded by the locator value 202 is within the second half of the data line. In certain examples, the memory controller circuit determines that the pair encoded by the locator value 202 is at a lower position versus the second (e.g., unencoded) pair, and sets the bit 302 formerly storing the additional locator value to a zero, else sets the bit to a one, e.g., to generate the original plaintext (e.g., where the memory controller circuit is further to restore the data (e.g., byte) encoded by the locator value 202).

Two Pairs, with One Pair in Each Half

In certain examples, if the original data bit 302 (e.g., in the data line) is a zero, the memory controller circuit is to encode the pair in the lower half (e.g., lower position) setting the ninth bit to zero, and if the original data bit is a one, the memory controller circuit is to encode the pair in the upper half (e.g., higher position), setting the ninth bit to one.

In certain examples, a decode of a modified data line (e.g., modified plaintext) using the additional locator value 302 includes the memory controller circuit determining if the modified data line includes an unencoded pair of values, e.g., and thus the memory controller circuit is to presume that the additional locator value 302 is used if so.

In certain examples, the additional locator value 302 being set to a zero indicates to the memory controller circuit that the pair of matching (e.g., repeated) values that is encoded by the locator value 202 is within the first half of the data line, and the additional locator value 302 being set to a one indicates to the memory controller circuit that the pair of matching (e.g., repeated) values that is encoded by the locator value 202 is within the second half of the data line.

In certain examples, the memory controller circuit determines that the pair encoded by the locator value 202 and additional locator (e.g., ninth) bit 302 is at lower position (e.g., lower half), and sets the bit formerly storing the additional locator value 302 to a zero, else sets the bit to a one, e.g., to generate the plaintext (e.g., where the memory controller circuit is further to restore the data (e.g., byte) encoded by the locator value 202).

In certain examples, such a formal can be extended to a data line (e.g., cache line) having three or more pairs. For example, where with more pairs, more choices can be made, e.g., if the encoded pair is in the higher half set of all pair positions, restore the additional (e.g., 9th) data bit to 1, if encoded pair in lower half set of all pair positions, restore the additional (e.g., 9th) data to 0. In certain examples, the memory controller circuit (e.g., during creation of the modified data line) can choose any pair from the higher or lower set of pair positions, e.g., where all pairs can be in the same quadrant, still half will be in higher set and half in lower set of pair positions.

In certain examples, the solution for the off-by-one problem relies on maintaining quadrants, e.g., move the quadrant with the compressed/encoded pair to the front (e.g., next to the locator which is the first byte in FIGS. 2 and 3). In this way, only the byte positions of the compressed quadrant are shifted (e.g. to the right) to make room for the locator byte at position 202. In certain examples, since with the ninth bit, the location of the encoded pair is deterministic, it is also deterministic which quadrant should be moved to the beginning of the line. For example, if quadrant 1 is where the encoded pair is located, then no quadrants need to move. For example, if quadrant 2 is where the encoded pair is located, it is swapped with quadrant l's location. For example, if quadrant 3 is where the encoded pair is located, its position is swapped with quadrant l's location. For example, if quadrant 4 is where the encode pair is located, it is swapped with quadrant l's location, assuring the locator value is always located at the beginning of the memory line (or at the same position) along with the affected quadrant. This leaves the byte positions in

In certain examples, the locator value 202 includes four bits to identify the repeated byte within a quadrant, three bits to identify the offset within the quadrant to this pair's compressed/missing byte, and 1 bit to identify which half of the data line the quadrant is located (e.g., and the optional additional locator bit (e.g., ninth bit) to identify which half if there are multiple pairs). In certain examples, where the quadrant with the encoded pair is swapped with the first quadrant position adjacent to the locator 202, the remaining quadrants maintain their positions (e.g., no bytes are shifted) and, thus, any visible pairs are valid within their respective quadrant on decode.

In certain examples, assuming all data is apparently random, if the conflict indicator in the matching pair mode (e.g., “birthday pair” mode) flow is set outside of data encryption, that will improve access control (e.g., detection of memory access using the wrong key). In certain examples, a memory lookup step can also store the correct keyID, key hash, or integrity value used to originally encrypt the stored cache line match the key currently used to access the memory line. In certain examples, if a line cannot be encoded, the data is “stamped” with this conflict indicator value. In certain examples, the indicator overwrites data, so the conflict table is used to store the original data (e.g., and in certain examples this causes a performance impact because memory is now accessed twice: once for the data line, and once to get the original data from the conflict table). Certain examples herein use the data line's (e.g., physical) address as an index into this conflict table (e.g., as an indexed array) to find the right entry. In addition to storing the data overwritten by the conflict indicator in the conflict table, certain examples also store the key ID that was used to encrypt the data (or store the key hash or an integrity hash). In certain examples that are performing these two memory operations, the values (e.g., keyID, key hash, or integrity value) can be used to check access control for the data line as well (e.g., to check if the stored key ID in the conflict table for the data line's address matches the key ID used to access the data line).

Certain examples herein (e.g., of a memory controller circuit) detect access control violations by decoding the data line and observing if the encoding rules were not followed (e.g., based on which pair was chosen to be encoded, e.g., if there were three pairs with a ninth bit algorithm on encode, either the pair in the highest or lowest position should have been encoded, but if on decode the pair in the middle position were found to be encoded, an access control violation or ciphertext corruption may be detected) or noting that the line could not be encoded in the first place, e.g., thus using a memory lookup anyway, which can also perform an access control check.

In certain examples, a data line is all zeros, and a memory controller circuit in matching encodings for an all zero line as every byte can be paired as they are all the same value (0) as well as a 100% encoding rate (and there is always a pair to encode). Randomly picking which byte pair to encode results in the different ciphertext for the same plaintext (all zeros). In certain examples, with a ninth bit algorithm, it is possible to pick from the half of pair locations corresponding to the encoding of the ninth bit, again allowing for 255 possible encodings for an all zero line resulting in 255 different possible ciphertexts. Note also, if the encrypted zero line were corrupted or read using the wrong key, it would decrypt to the random case where the access control check can be applied in certain examples. In certain examples, there is a threshold on the number of pairs (e.g., three pairs) to determine when to use access control (e.g., where it only applies to random or corrupted data, e.g., as decrypted data revealing many matching pairs is unlikely to be corrupt).

In certain examples, a modified data line (e.g., modified cache line) including a locator value is then to be encrypted, e.g., according to a key as discussed herein, and then the encrypted version of the modified data line is stored. In certain examples, an encrypted version of the modified data line is decrypted, and then the modified data line is returned by a memory controller circuit in matching pair mode (e.g., “birthday pair” mode) back to the original data line (e.g., plaintext), e.g., according to the examples (e.g., sub modes) discussed herein.

In certain examples, the modified data line (e.g., the entire data line) is encrypted by a block cipher (for example, a symmetric-key tweakable block cipher, e.g., the Threefish cipher). In certain examples, the memory address may also be used as a tweak. In certain examples, a block cipher will diffuse the change due to the alternate pair encoding across the entire memory line, and the result is completely different ciphertext for any change in the pair encoded. In certain examples, a CBC mode fully diffuses the encoding across the whole memory line. CBC mode may also include the memory line address to further localize the ciphertext. In some examples, additional bits beyond the ninth bit can be similarly encoded, e.g., when a cache line is 128 bytes long, a tenth bit may be used to determine which side of the line the encoded pair is located when 4 or more pairs are available to reconstitute the original ninth and tenth data bit values, and so on.

### Rules for Data Integrity:

With multiple pairs there can be rules that also function as access control and/or integrity without requiring any additional encoding, e.g., if the rule is the highest value pair is the one encoded, then on an invalid read (e.g., using wrong key or reading a corrupted written line from memory), if the encoded byte value is lower than another encodable pair it is in violation of the rule and detected as a violation of access control and/or integrity. In certain examples of a ninth bit algorithm, if there are three pairs on encode, the rule is either the highest or lowest pair position is encoded. This means on a decode, if the middle pair position was found to be encoded, an access control violation or data corruption is detected. In certain examples, when many pairs are detected on decode, the data is assumed to be legitimate as incorrectly decrypted ciphertext should result in random decrypted data with minimal matching pairs.

To cover the entire 64-byte cacheline, embodiments may also use a nine-bit locator, displacing 9-bits of repeated data. Byte alignment may still be preserved where the first 6 bits of the nine-bit locator locate the byte-aligned repeating 9-bit value within the 64-byte cacheline, and the remaining 3-bits of the nine-bit locator identify the byte-aligned location within the same quadrant (with wrap-around) of the repeated 9-bit value to be replaced by the nine-bit locator. The locator may then be located at the beginning (or in embodiments, the end) of the cacheline, concatenating (shifting) all the remaining bits together to fill the hole left by the repeating 9-bit value that was removed to make room for the nine-bit locator. For the special case of adjacencies, where the last bit of the first byte aligned 9-bit value overlaps with the first bit for the repeated byte aligned 9-bit value, the second 9-bit value is assumed to not be byte aligned but shifted one bit over so as not to overlap with the last bit of the first repeating 9-bit value. Similarly, if the 6-bits of the locator identify the last byte location within a quadrant as the location of the first repeated 9-bit value, the last bit of the repeated 9-bit value may be assumed to wrap-around to the beginning of the quadrant it is within. In this way, an encoding rate of ˜60% can be achieved for even random data based on the birthday bounds probability of a 9-bit value collision within a quadrant (˜20%), for all four quadrants, while maintaining byte alignments typical for computer data. Similar embodiments exist for ten-bit locators, 11-bit locators and so on, allowing for encodings covering larger sized cachelines.

### Key Refresh:

In certain examples, the matching pair mode (e.g., “birthday pair” mode) is used with a key refresh, e.g., where periodically the memory encryption key is changed. In certain examples, because the matching pair mode (e.g., “birthday pair” mode) can produce numerous (e.g., 100s) of alternate ciphertexts for the same plaintext, it fills the gap between periodic key refreshes. In certain examples, when the encryption key changes, entirely new ciphertexts are produced even for the exact same plaintexts.

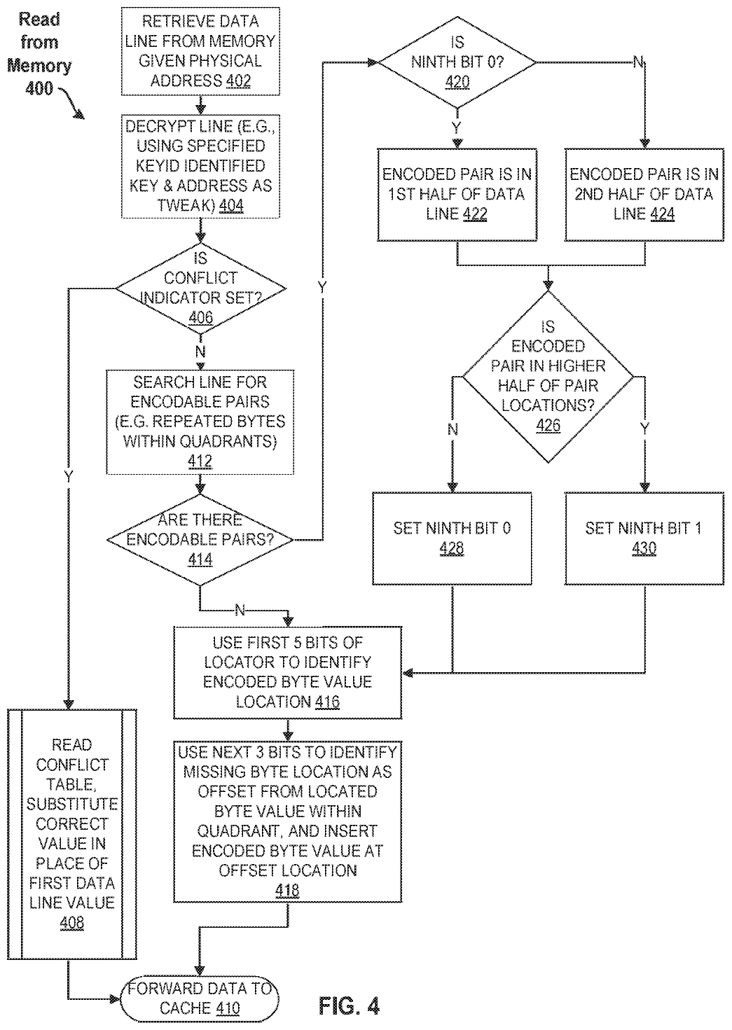

FIG. 4 illustrates an example of operations 400 for a method of performing a read from memory with repeated value encoding according to examples of the disclosure. Some or all of the operations 400 (or other processes described herein, or variations, and/or combinations thereof) are performed under the control of one or more computer systems configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 400 are performed by a component(s) of the other figures (e.g., memory controller circuit 116).

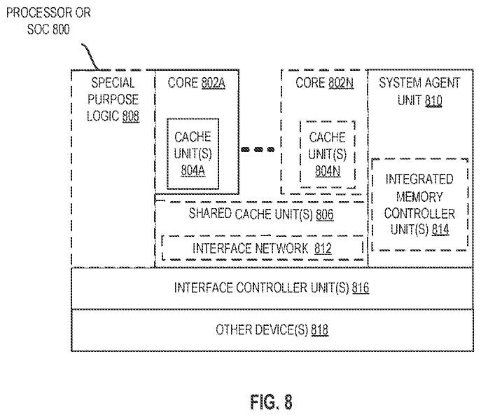

The operations 400 include, at block 402, retrieving a data line from memory given a particular (e.g., physical) address. The operations 400 further include, at block 404, decrypting the data line (e.g., using a specified keyID, identified key, and/or tweak). The operations 400 further include, at block 406, checking if a portion of the data line is a conflict indicator value (e.g., lookup indicator (IL)), and if yes, proceeding to block 408, and if no, proceeding to block 412. Some examples place the conflict indicator test 406 before decryption of the line 404. The operations 400 further include, at block 408, reading the conflict resolution data structure, e.g. by using the data line's address as an index into an array structure, to determine the corresponding (e.g., original) value, and substituting that correct value in place of the conflict indicator value reproducing the original data line. The operations 400 further include, at block 410, forwarding the data to a cache (e.g., cache 112 in FIG. 1 or a one or more caches in the other figures, e.g., in FIG. 8). The operations 400 further include, at block 412, searching the decrypted data line for encodable pairs (for example, repeated values (e.g., repeated byte values), e.g., repeated within a single quadrant). The operations 400 further include, at block 414, checking if there are one or more encodable pairs (e.g., one or more than one set of repeated values within quadrants), and if yes, proceeding to block 420, and if no (there are no encodable pairs), proceeding to block 416, e.g., remembering that the encoded pair is in the first half of the data line. The operations 400 further include, at block 416, knowing which half of the cache line contains the encoded pair, using a first portion of the locator value within the data line (e.g., 5 bit locator value 304 of locator value 202 in data line 200 in FIG. 3) to identify the encoded (e.g., byte) value location (e.g., the location of the repeated value in the data line whose value is to be copied/inserted to re-fill the deleted instance of that value). The operations 400 further include, at block 418, using a second portion of the locator value within the data line (e.g., 3 bit locator value 306 of locator value 202 in data line 200 in FIG. 3) to identify the location of the missing (e.g., byte) value (e.g., the location where the repeated value in the data line is to be copied/inserted into to re-fill the deleted instance of that value within a quadrant to restore the original data line to be forwarded to cache at 410). The operations 400 further include, at block 420, checking if the additional locator value (e.g., additional locator value 302 (e.g., 9th bit) in FIG. 3) is a zero, and if yes, proceeding to block 422, and if no, proceeding to block 424. The operations 400 further include, at block 422, if the additional locator value is zero, determining that the encoded pair is in the first half of the data line 200A. The operations 400 further include, at block 424, if the additional locator value is zero, determining that the encoded pair is in the second half of the data line 200B. The operations 400 further include, at block 426, checking if the encoded pair (e.g., encoded position determined by the locator value and ninth bit) is in the higher half of all pair positions (e.g., the highest position) in the data line, and if no (the encoded pair is not the highest or in the higher half of pair positions as compared to all the other encodable pairs discovered at step 412), proceeding to block 428, and if yes, proceeding to block 430. Examples enforcing access control may further check if there are two encodable pairs that the position of the third encodable pair is in the middle position, neither the highest nor the lowest position, triggering an access control violation error by e.g. poisoning the cache line. The operations 400 further include, at block 428, if the check at 426 is no, setting then, remembering which half of the data line contained the encoded pair (422 or 424), sending that modified data line to block 416. The operations 400 further include, at block 430, if the check at 426 is yes, setting the additional locator bit position 302 to one, (e.g. restoring the original data value to one), and then, remembering which half the data line contained the encode pair (422 or 424), sending that modified data line to block 416.

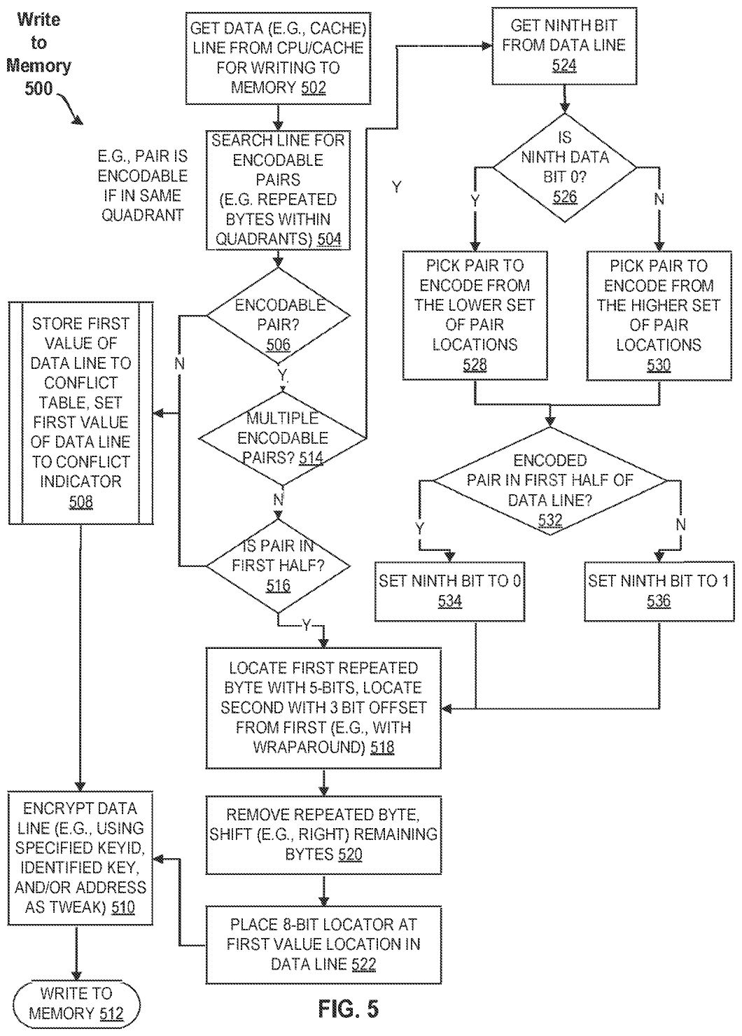

FIG. 5 illustrates an example of operations 500 for a method of performing a write to memory with repeated value encoding according to examples of the disclosure. Some or all of the operations 500 (or other processes described herein, or variations, and/or combinations thereof) are performed under the control of one or more computer systems configured with executable instructions and are implemented as code (e.g., executable instructions, one or more computer programs, or one or more applications) executing collectively on one or more processors, by hardware or combinations thereof. The code is stored on a computer-readable storage medium, for example, in the form of a computer program comprising instructions executable by one or more processors. The computer-readable storage medium is non-transitory. In some examples, one or more (or all) of the operations 500 are performed by a component(s) of the other figures (e.g., memory controller circuit 116).

The operations 500 include, at block 502, receiving a data line (e.g., from a processor or processor cache) for writing to memory. The operations 500 further include, at block 504, searching the data line for encodable pairs (for example, repeated values (e.g., repeated byte), e.g., repeated within a single quadrant, for all quadrants). The operations 500 further include, at block 506, checking if there is at least one encodable pair (e.g., one set of repeated values within a quadrant), and if yes, proceeding to block 514, and info, proceeding to block 508. The operations 500 further include, at block 508, storing an original value of the data line (e.g., value at the same location and same width as a locator value) into a data structure (e.g., conflict table indexed by the memory line address) (e.g., data structure 126 in FIG. 1), and replacing the original value in the data line with a locator value that identifies there was a conflict with the encoding scheme and the data could not be encoded because there were no matching pairs. The operations 500 further include, at block 510, encrypting the modified data line (e.g., using a specified keyID, identified key, and/or tweak (e.g., physical address of the data line as the tweak)). Some examples alternatively set the conflict indicator after encrypting the data line and storing the encrypted portion after 510 corresponding to the locator value position and size in the conflict table such that the conflict table need not be additionally encrypted and improving access control. The at the address. The operations 500 further include, at block 514, checking if there are multiple encodable pairs (e.g., multiple respective sets of repeated values within one or more quadrants), and if yes, proceeding to block 524, and if no, proceeding to block 516 in the case there is only one encodable pair. The operations 500 further include, at block 516, checking if there is a pair in a first half of the data line, and if so, proceeding to block 518, and if no, proceeding to block 508 as there is no encoding for only one pair that is in the second half of the data line. The operations 500 further include, at block 518, knowing what half the encodable pair is in, locating a first instance of the repeated value of the encodable pair within the half (e.g., of the repeated values) and generating a first portion of a locator value (e.g., 5 bit locator value 304 of locator value 202 in data line 200 in FIG. 3) to identify the repeated (e.g., byte) value location (e.g., the location of the repeated value in the data line), and locating a second instance of the repeated value of the encodable pair within the same quadrant (e.g., of the repeated value within a quadrant) and generating a second portion of the locator value within the data line (e.g., 3 bit locator value 306 of locator value 202 in data line 200 in FIG. 3) to identify the location of the to-be-deleted (e.g., byte) value (and in certain examples, swapping the quadrant with the encoded pair with the first quadrant 200-1). The operations 500 further include, at block 520, shifting (e.g., right shifting) the leftmost bits to remove the second instance of the repeated value of the encodable pair, e.g., thus deleting the second instance of the repeated value of the encodable pair to make room for the locator value in the data line (or quadrant with the encoded pair in it). The operations 500 further include, at block 522, inserting (e.g., concatenating) the locator value (e.g., 8 bits wide) into the space created by the shift at block 520, e.g., to generate a modified data line including the locator value (e.g., where the modified data line is the same width as the data line (e.g., 512-bits) retrieved at block 502). Examples may further swap the quadrant with the encoded pair with the first quadrant to the byte shifting to just the affected quadrant. The operations 500 further include, at block 524, reading the data bit value (e.g., the 9th bit) in the data line that is to be used for an additional locator bit (e.g., additional locator value 302 (e.g., 9th bit) in FIG. 3). The operations 500 further include, at block 526, checking if that data bit is a zero, and if yes, proceeding to block 528, and if no, proceeding to block 530. The operations 500 further include, at block 528, if the check at 526 is yes, picking a pair to encode from the lower set (e.g., lowest set) of the encodable pair locations. The operations 500 further include, at block 530, if the check at 526 is no, picking a pair to encode (e.g. at random) from the higher set (e.g., highest set) of the encodable pair locations. In certain examples, a list of encodable pairs (e.g., where each pair is within a same quadrant) is generated at block 504, and this list is then sorted based on the positions of the pairs. In certain examples, this sorted list is divided into half, with the lower positions (e.g., closer to the of the cache line 200. In certain examples, a (e.g., 512b) data line has 64 elements indexed 1 to 64 and the list generated at block 504 indicates a first pair of matching values at indices 3 and 6 [3,6] and a second pair of matching values at indices 4 and 11 [4,11], and thus the first index from both of the pairs is used to sort the list {3, 4}. In certain examples, the pair picked to encode from a set of encodable pairs is varied for a same plaintext, e.g., to generate different cyphertext for multiple encodings of a same plaintext. As another example, for a “ninth bit” algorithm, the memory controller circuit is to encode what the original data bit the ninth bit is replacing, so it would encode the lowest set (e.g., the pair starting at index 3 in the example above) if the data bit is 0, and the highest set (e.g., the pair starting at index 4 in the example above) if the data bit is 1. Examples that wish to perform access control may additionally check if there are three encodable pairs and, as a rule, only encode either the highest or lowest pair position depending on the value of the ninth data bit. The operations 500 further include, at block 532, checking if the encoded pair is in the first half (e.g., 200A) or second half (e.g., 200B) of the data line, and if yes, it is in the first half, proceeding to block 534, and if no, proceeding to block 536. The operations 500 further include, at block 534, if the check at 532 is yes, setting the additional locator bit position (e.g., 9th bit) to zero, e.g. indicating the encoded pair is in the first half 200A, and then sending that modified data line to block 518 remembering in which half it is located. The operations 500 further include, at block 536, if the check at 532 is no, setting the additional locator bit (e.g., 9th bit) to one, e.g. indicating the encoded pair is in the second half 200B, and then sending that modified data line to block 518.

In certain examples, there are triplets of the same value (e.g. 3 elements (e.g., bytes) with the same value within a quadrant), and those triplets are encoded as multiple pairs, e.g. the first value and the middle value produces one locator value, and the middle value and the last value produce a different locator value becoming alternate pairs. In certain examples, the first value and the last value can be a third pair.

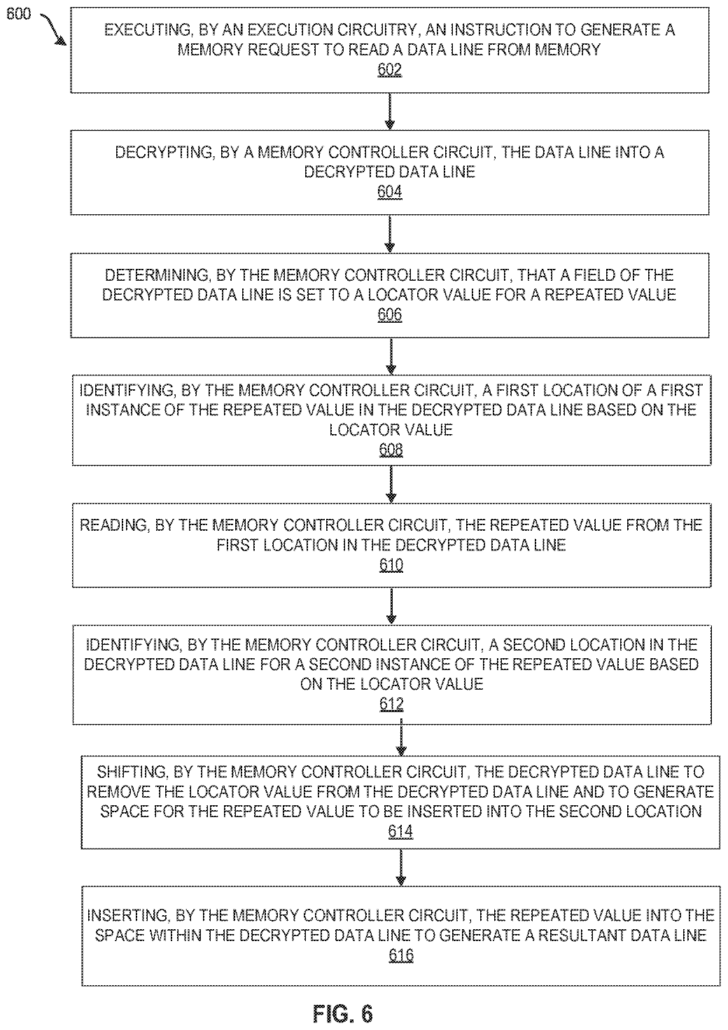

FIG. 6 illustrates another example of operations 600 for a method of performing a read from memory with repeated value encoding according to examples of the disclosure. Some or all of the operations 600 (or other processes described herein, or variations, and/or combinations thereof) are performed under the control of one or more computer systems configured with executable instructions and are implemented as code (e.g., executable instructions, one or more computer programs, or one or more applications) executing collectively on one or more processors, by hardware or combinations thereof. The code is stored on a computer-readable executable by one or more processors. The computer-readable storage medium is non-transitory. In some examples, one or more (or all) of the operations 600 are performed by a component(s) of the other figures (e.g., memory controller circuit 116).

The operations 600 include, at block 602, executing, by an execution circuitry, an instruction to generate a memory request to read a data line from memory. The operations 600 further include, at block 604, decrypting, by a memory controller circuit, the data line into a decrypted data line. The operations 600 further include, at block 606, determining, by the memory controller circuit, that a field of the decrypted data line is set to a locator value for a repeated value. The operations 600 further include, at block 608, identifying, by the memory controller circuit, a first location of a first instance of the repeated value in the decrypted data line based on the locator value. The operations 600 further include, at block 610, reading, by the memory controller circuit, the repeated value from the first location in the decrypted data line. The operations 600 further include, at block 612, identifying, by the memory controller circuit, a second location in the decrypted data line for a second instance of the repeated value based on the locator value. The operations 600 further include, at block 614, shifting, by the memory controller circuit, the decrypted data line to remove the locator value from the decrypted data line and to generate space for the repeated value to be inserted into the second location. The operations 600 further include, at block 616, inserting, by the memory controller circuit, the repeated value into the space within the decrypted data line to generate a resultant data line.

Some examples utilize instruction formats described herein. Some examples are implemented in one or more computer architectures, cores, accelerators, etc. Some examples are generated or are IP cores. Some examples utilize emulation and/or translation.

At least some examples of the disclosed technologies can be described in view of the following examples.

In one set of examples, an apparatus (e.g., a hardware processor) includes an execution circuitry to execute an instruction to generate a memory request to read a data line from memory; and a memory controller circuit to decrypt the data line into a decrypted data line, determine that a field of the decrypted data line is set to a locator value for a repeated value, identify a first location of a first instance of the repeated value in the decrypted data line based on the locator value, read the repeated value from the first location in the decrypted data line, identify a second value, shift the decrypted data line to remove the locator value from the decrypted data line and to generate space for the repeated value to be inserted into the second location, and insert the repeated value into the space within the decrypted data line to generate a resultant data line. In certain examples, the memory controller circuit is to shift bits in the decrypted data line to the left of the second location by a width of the repeated value to remove the locator value and generate the space for the repeated value to be inserted into the second location, and not shift bits in the decrypted data line to the right of the second location. In certain examples, the memory controller circuit is to determine that the field of the decrypted data line is not set to a conflict indicator value, and perform the identify the first location, the read, the identify the second location, the shift, and the insert in response to the determination that the field of the decrypted data line is not set to the conflict indicator value. In certain examples, the locator value comprises a first value to indicate the first location of the first instance of the repeated value within a first proper subset of the decrypted data line, and a second value to indicate an offset within a second proper subset of the decrypted data line. In certain examples, the memory controller circuit is further to check another locator bit of the decrypted data line, wherein the bit being set to a first value indicates to the memory controller circuit that the first location and the second location of the repeated value are in a first half of the decrypted data line, and the bit being set to a second value indicates to the memory controller circuit that the first location and the second location of the repeated value are in a second half of the decrypted data line. In certain examples, the memory controller circuit is further to receive a second data line for writing to the memory; search the second data line for a repeated value; determine that the repeated value in the second data line is identifiable using a second locator value for a repeated value in the second data line; in response to the determination, generate the second locator value for the repeated value in the second data line, remove a second instance of the repeated value from the second data line, and insert the second locator value into the second data line; encrypt the second data line that includes the second locator value into an encrypted data line; and cause a write of the encrypted data line to the memory. In certain examples, the memory controller circuit is further to, before the encrypt, set another locator bit of the second data line to a first value in response to a first instance and a second instance of the repeated value in the second data line being in a first half of the second data line, and to a second value in response to the first instance and the second instance of the repeated value in the second data line being in a second half of the second data line.

In another set of examples, a method includes executing, by an execution circuitry, an instruction to generate a memory request to read a data line from memory; decrypting, by a memory controller circuit, the data line into a decrypted data line; determining, by the memory value; identifying, by the memory controller circuit, a first location of a first instance of the repeated value in the decrypted data line based on the locator value; reading, by the memory controller circuit, the repeated value from the first location in the decrypted data line; identifying, by the memory controller circuit, a second location in the decrypted data line for a second instance of the repeated value based on the locator value; shifting, by the memory controller circuit, the decrypted data line to remove the locator value from the decrypted data line and to generate space for the repeated value to be inserted into the second location; and inserting, by the memory controller circuit, the repeated value into the space within the decrypted data line to generate a resultant data line. In certain examples, the shifting comprising shifting bits in the decrypted data line to the left of the second location by a width of the repeated value to remove the locator value and generate the space for the repeated value to be inserted into the second location, and not shifting bits in the decrypted data line to the right of the second location. In certain examples, the method includes determining, by the memory controller circuit, that the field of the decrypted data line is not set to a conflict indicator value, and performing the identify the first location, the read, the identify the second location, the shift, and the insert in response to the determining that the field of the decrypted data line is not set to the conflict indicator value. In certain examples, the locator value comprises a first value to indicate the first location of the first instance of the repeated value within a first proper subset of the decrypted data line, and a second value to indicate an offset within a second proper subset of the decrypted data line. In certain examples, the method includes checking, by the memory controller circuit, another locator bit of the decrypted data line, wherein the bit being set to a first value indicates to the memory controller circuit that the first location and the second location of the repeated value are in a first half of the decrypted data line, and the bit being set to a second value indicates to the memory controller circuit that the first location and the second location of the repeated value are in a second half of the decrypted data line. In certain examples, the method includes receiving, by the memory controller circuit, a second data line for writing to the memory; search the second data line for a repeated value; determining, by the memory controller circuit, that the repeated value in the second data line is identifiable using a second locator value for a repeated value in the second data line; in response to the determining, generating, by the memory controller circuit, the second locator value for the repeated value in the second data line, remove a second instance of the repeated value from the second data line, and insert the second locator value into the second data line; encrypting, by the memory controller circuit, the second data line that includes the second locator value into an encrypted data line; and causing, by the memory controller circuit, a write of the encrypted data line to the memory. In certain examples, the method includes, before the encrypting, setting, by to a first instance and a second instance of the repeated value in the second data line being in a first half of the second data line, and to a second value in response to the first instance and the second instance of the repeated value in the second data line being in a second half of the second data line.

In yet another set of examples, a system includes a memory; an execution circuitry to execute an instruction to generate a memory request to read a data line from the memory; and a memory controller circuit to decrypt the data line into a decrypted data line, determine that a field of the decrypted data line is set to a locator value for a repeated value, identify a first location of a first instance of the repeated value in the decrypted data line based on the locator value, read the repeated value from the first location in the decrypted data line, identify a second location in the decrypted data line for a second instance of the repeated value based on the locator value, shift the decrypted data line to remove the locator value from the decrypted data line and to generate space for the repeated value to be inserted into the second location, and insert the repeated value into the space within the decrypted data line to generate a resultant data line. 16. The system of claim 15, wherein the memory controller circuit is to shift bits in the decrypted data line to the left of the second location by a width of the repeated value to remove the locator value and generate the space for the repeated value to be inserted into the second location, and not shift bits in the decrypted data line to the right of the second location. In certain examples, the memory controller circuit is to determine that the field of the decrypted data line is not set to a conflict indicator value, and perform the identify the first location, the read, the identify the second location, the shift, and the insert in response to the determination that the field of the decrypted data line is not set to the conflict indicator value. In certain examples, the locator value comprises a first value to indicate the first location of the first instance of the repeated value within a first proper subset of the decrypted data line, and a second value to indicate an offset within a second proper subset of the decrypted data line. In certain examples, the memory controller circuit is further to check another locator bit of the decrypted data line, wherein the bit being set to a first value indicates to the memory controller circuit that the first location and the second location of the repeated value are in a first half of the decrypted data line, and the bit being set to a second value indicates to the memory controller circuit that the first location and the second location of the repeated value are in a second half of the decrypted data line. In certain examples, the memory controller circuit is further to receive a second data line for writing to the memory; search the second data line for a repeated value; determine that the repeated value in the second data line is identifiable using a second locator value for a repeated value in the second data line; in response to the determination, generate the second locator value for the repeated value in the second data line, remove a second the second data line; encrypt the second data line that includes the second locator value into an encrypted data line; and cause a write of the encrypted data line to the memory. In certain examples, the memory controller circuit is further to, before the encrypt, set another locator bit of the second data line to a first value in response to a first instance and a second instance of the repeated value in the second data line being in a first half of the second data line, and to a second value in response to the first instance and the second instance of the repeated value in the second data line being in a second half of the second data line.

Exemplary architectures, systems, etc. that the above may be used in are detailed below.

### Exemplary Computer Architectures

Detailed below are descriptions of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

FIG. 1 illustrates embodiments of an exemplary system. Multiprocessor system 100 is a point-to-point interconnect system and includes a plurality of processors including a first processor 170 and a second processor 180 coupled via a point-to-point interconnect 150. In some embodiments, the first processor 170 and the second processor 180 are homogeneous. In some embodiments, first processor 170 and the second processor 180 are heterogenous.

Processors 170 and 180 are shown including integrated memory controller (IMC) units circuitry 172 and 182, respectively. Processor 170 also includes as part of its interconnect controller units point-to-point (P-P) interfaces 176 and 178; similarly, second processor 180 includes P-P interfaces 186 and 188. Processors 170, 180 may exchange information via the point-to-point (P-P) interconnect 150 using P-P interface circuits 178, 188. IMCs 172 and 182 couple the processors 170, 180 to respective memories, namely a memory 132 and a memory 134, which may be portions of main memory locally attached to the respective processors.

Processors 170, 180 may each exchange information with a chipset 190 via individual P-P interconnects 152, 154 using point to point interface circuits 176, 194, 186, 198. Chipset 190 may optionally exchange information with a coprocessor 138 via a high-performance interface 192. In some embodiments, the coprocessor 138 is a special-purpose processor, such as, for example, a high-throughput MIC processor, a network or communication processor, compression engine, graphics processor, GPGPU, embedded processor, or the like.

A shared cache (not shown) may be included in either processor 170, 180 or outside of both processors, yet connected with the processors via P-P interconnect, such that either or both processors' local cache information may be stored in the shared cache if a processor is placed into a low power mode.

Chipset 190 may be coupled to a first interconnect 116 via an interface 196. In some embodiments, first interconnect 116 may be a Peripheral Component Interconnect (PCI) interconnect, or an interconnect such as a PCI Express interconnect or another I/O interconnect. In some embodiments, one of the interconnects couples to a power control unit (PCU) 117, which may include circuitry, software, and/or firmware to perform power management operations with regard to the processors 170, 180 and/or co-processor 138. PCU 117 provides control information to a voltage regulator to cause the voltage regulator to generate the appropriate regulated voltage. PCU 117 also provides control information to control the operating voltage generated. In various embodiments, PCU 117 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 117 is illustrated as being present as logic separate from the processor 170 and/or processor 180. In other cases, PCU 117 may execute on a given one or more of cores (not shown) of processor 170 or 180. In some cases, PCU 117 may be implemented as a microcontroller (dedicated or general-purpose) or other control logic configured to execute its own dedicated power management code, sometimes referred to as P-code. In yet other embodiments, power management operations to be performed by PCU 117 may be implemented externally to a processor, such as by way of a separate power management integrated circuit (PMIC) or another component external to the processor. In yet other embodiments, power management operations to be performed by PCU 117 may be implemented within BIOS or other system software.

Various I/O devices 114 may be coupled to first interconnect 116, along with an interconnect (bus) bridge 118 which couples first interconnect 116 to a second interconnect 120. In some embodiments, one or more additional processor(s) 115, such as coprocessors, high-throughput MIC processors, GPGPU's, accelerators (such as, e.g., graphics accelerators or digital signal processing (DSP) units), field programmable gate arrays (FPGAs), or any other processor, are coupled to first interconnect 116. In some embodiments, second interconnect 120 may be a low pin count (LPC) interconnect. Various devices may be coupled to second interconnect 120 including, for example, a keyboard and/or mouse 122, communication devices 127 and a storage unit circuitry 128. Storage unit circuitry 128 may be a disk drive or other mass storage device which may include instructions/code and data 130, in some embodiments. Further, an audio I/O 124 may be coupled to second interconnect 120. Note that other architectures than the point-to-point architecture described above are possible. For example, instead of the point-to-point architecture, a system such as multiprocessor system 100 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 2 illustrates a block diagram of embodiments of a processor 200 that may have more than one core, may have an integrated memory controller, and may have integrated graphics. The solid lined boxes illustrate a processor 200 with a single core 202A, a system agent 210, a set of one or more interconnect controller units circuitry 216, while the optional addition of the dashed lined boxes illustrates an alternative processor 200 with multiple cores 202(A)-(N), a set of one or more integrated memory controller unit(s) circuitry 214 in the system agent unit circuitry 210, and special purpose logic 208, as well as a set of one or more interconnect controller units circuitry 216. Note that the processor 200 may be one of the processors 170 or 180, or co-processor 138 or 115 of FIG. 1.

Thus, different implementations of the processor 200 may include: 1) a CPU with the special purpose logic 208 being integrated graphics and/or scientific (throughput) logic (which may include one or more cores, not shown), and the cores 202(A)-(N) being one or more general purpose cores (e.g., general purpose in-order cores, general purpose out-of-order cores, or a combination of the two); 2) a coprocessor with the cores 202(A)-(N) being a large number of special purpose cores intended primarily for graphics and/or scientific (throughput); and 3) a coprocessor with the cores 202(A)-(N) being a large number of general purpose in-order cores. Thus, the processor 200 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 200 may be a part of and/or may be implemented on one or more substrates using any of a number of process technologies, such as, for example, BiCMOS, CMOS, or NMOS.

A memory hierarchy includes one or more levels of cache unit(s) circuitry 204(A)-(N) within the cores 202(A)-(N), a set of one or more shared cache units circuitry 206, and external memory (not shown) coupled to the set of integrated memory controller units circuitry 214. The set of one or more shared cache units circuitry 206 may include one or more mid-level caches, such as level 2 (L2), level 3 (L3), level 4 (L4), or other levels of cache, such as a last level cache (LLC), and/or combinations thereof. While in some embodiments ring-based interconnect network circuitry 212 interconnects the special purpose logic 208 (e.g., integrated graphics logic), the set of shared cache units circuitry 206, and the system agent unit circuitry 210, alternative embodiments use any number of well-known techniques for interconnecting such units. In some embodiments, coherency is maintained between one or more of the shared cache units circuitry 206 and cores 202(A)-(N).

In some embodiments, one or more of the cores 202(A)-(N) are capable of multi-threading. The system agent unit circuitry 210 includes those components coordinating and operating cores 202(A)-(N). The system agent unit circuitry 210 may include, for example, power control unit (PCU) circuitry and/or display unit circuitry (not shown). The PCU may be or may include logic and components needed for regulating the power state of the cores 202(A)-(N) and/or the special purpose logic 208 (e.g., integrated graphics logic). The display unit circuitry is for driving one or more externally connected displays.

The cores 202(A)-(N) may be homogenous or heterogeneous in terms of architecture instruction set; that is, two or more of the cores 202(A)-(N) may be capable of executing the same instruction set, while other cores may be capable of executing only a subset of that instruction set or a different instruction set.

### Exemplary Core Architectures

### In-Order and Out-of-Order Core Block Diagram

FIG. 3(A) is a block diagram illustrating both an exemplary in-order pipeline and an exemplary register renaming, out-of-order issue/execution pipeline according to embodiments of the invention. FIG. 3(B) is a block diagram illustrating both an exemplary embodiment of an in-order architecture core and an exemplary register renaming, out-of-order issue/execution architecture core to be included in a processor according to embodiments of the invention. The solid lined boxes in FIGS. 3(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 3(A), a processor pipeline 300 includes a fetch stage 302, an optional length decode stage 304, a decode stage 306, an optional allocation stage 308, an optional renaming stage 310, a scheduling (also known as a dispatch or issue) stage 312, an optional register read/memory read stage 314, an execute stage 316, a write back/memory write stage 318, an optional exception handling stage 322, and an optional commit stage 324. One or more operations can be performed in each of these processor pipeline stages. For example, during the fetch stage 302, one or more instructions are fetched from instruction memory, during the decode stage 306, the one or more fetched instructions may be decoded, addresses (e.g., load store unit (LSU) addresses) using forwarded register ports may be generated, and branch forwarding (e.g., immediate offset or an link register (LR)) may be performed. In one embodiment, the decode stage 306 and the register read/memory read stage 314 may be combined into one pipeline stage. In one embodiment, during the execute stage 316, the decoded instructions may be executed, LSU address/data pipelining to an Advanced Microcontroller Bus (AHB) interface may be performed, multiply and add operations may be performed, arithmetic operations with branch results may be performed, etc.

By way of example, the exemplary register renaming, out-of-order issue/execution core architecture may implement the pipeline 300 as follows: 1) the instruction fetch 338 performs the fetch and length decoding stages 302 and 304; 2) the decode unit circuitry 340 performs the decode stage 306; 3) the rename/allocator unit circuitry 352 performs the allocation stage 308 and renaming stage 310; 4) the scheduler unit(s) circuitry 356 performs the schedule stage 312; 5) the physical register file(s) unit(s) circuitry 358 and the memory unit circuitry 370 perform the register read/memory read stage 314; the execution cluster 360 perform the execute stage 316; 6) the memory unit circuitry 370 and the physical register file(s) unit(s) circuitry 358 perform the write back/memory write stage 318; 7) various units (unit circuitry) may be involved in the exception handling stage 322; and 8) the retirement unit circuitry 354 and the physical register file(s) unit(s) circuitry 358 perform the commit stage 324.

FIG. 3(B) shows processor core 390 including front-end unit circuitry 330 coupled to an execution engine unit circuitry 350, and both are coupled to a memory unit circuitry 370. The core 390 may be a reduced instruction set computing (RISC) core, a complex instruction set computing (CISC) core, a very long instruction word (VLIW) core, or a hybrid or alternative core type. As yet another option, the core 390 may be a special-purpose core, such as, for example, a network or communication core, compression engine, coprocessor core, general purpose computing graphics processing unit (GPGPU) core, graphics core, or the like.

The front end unit circuitry 330 may include branch prediction unit circuitry 332 coupled to an instruction cache unit circuitry 334, which is coupled to an instruction translation lookaside buffer (TLB) 336, which is coupled to instruction fetch unit circuitry 338, which is coupled to decode unit circuitry 340. In one embodiment, the instruction cache unit circuitry 334 is included in the memory unit circuitry 370 rather than the front-end unit circuitry 330. The decode unit circuitry 340 (or decoder) may decode instructions, and generate as an output one or more micro-operations, micro-code entry points, microinstructions, other instructions, or other control signals, which are decoded from, or which otherwise reflect, or are derived from, the original instructions. The decode unit circuitry 340 may further include an address generation unit circuitry (AGU, not shown). In one embodiment, the AGU generates an LSU address using forwarded register ports, and may further perform branch forwarding (e.g., immediate offset branch forwarding, LR register branch forwarding, etc.). The decode unit circuitry 340 may be implemented using various different mechanisms. Examples of suitable mechanisms include, but are not limited to, look-up tables, hardware implementations, programmable logic arrays (PLAs), microcode read only memories (ROMs), etc. In one embodiment, the core 390 includes a microcode ROM (not shown) or other medium that stores microcode for certain macroinstructions (e.g., in decode unit circuitry 340 or otherwise within the front end unit circuitry 330). In one embodiment, the decode unit circuitry 340 includes a micro-operation (micro-op) or operation cache (not shown) to hold/cache decoded operations, micro-tags, or micro-operations generated during the decode or other stages of the processor pipeline 300. The decode unit circuitry 340 may be coupled to rename/allocator unit circuitry 352 in the execution engine unit circuitry 350.

The execution engine circuitry 350 includes the rename/allocator unit circuitry 352 coupled to a retirement unit circuitry 354 and a set of one or more scheduler(s) circuitry 356. The scheduler(s) circuitry 356 represents any number of different schedulers, including reservations stations, central instruction window, etc. In some embodiments, the scheduler(s) circuitry 356 can include arithmetic logic unit (ALU) scheduler/scheduling circuitry, ALU queues, arithmetic generation unit (AGU) scheduler/scheduling circuitry, AGU queues, etc. The scheduler(s) circuitry 356 is coupled to the physical register file(s) circuitry 358. Each of the physical register file(s) circuitry 358 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one embodiment, the physical register file(s) unit circuitry 358 includes vector registers unit circuitry, writemask registers unit circuitry, and scalar register unit circuitry. These register units may provide architectural vector registers, vector mask registers, general-purpose registers, etc. The physical register file(s) unit(s) circuitry 358 is overlapped by the retirement unit circuitry 354 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 354 and the physical register file(s) circuitry 358 are coupled to the execution cluster(s) 360. The execution cluster(s) 360 includes a set of one or more execution units circuitry 362 and a set of one or more memory access circuitry 364. The execution units circuitry 362 may perform various arithmetic, logic, floating-point or other types of operations (e.g., shifts, addition, subtraction, multiplication) and on various types of data (e.g., scalar floating-point, packed integer, packed floating-point, vector integer, vector floating-point). While some embodiments may include a number of execution units or execution unit circuitry dedicated to specific functions or sets of functions, other embodiments may include only one execution unit circuitry or multiple execution units/execution unit circuitry that all perform all functions. The scheduler(s) circuitry 356, physical register file(s) unit(s) circuitry 358, and execution cluster(s) 360 are shown as being possibly plural because certain embodiments create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) unit circuitry, and/or execution cluster—and in the case of a separate memory access pipeline, certain embodiments are implemented in which only the execution cluster of this pipeline has the memory access unit(s) circuitry 364). It should also be understood that where separate pipelines are used, one or more of these pipelines may be out-of-order issue/execution and the rest in-order.

In some embodiments, the execution engine unit circuitry 350 may perform load store unit (LSU) address/data pipelining to an Advanced Microcontroller Bus (AHB) interface (not shown), and address phase and writeback, data phase load, store, and branches.

The set of memory access circuitry 364 is coupled to the memory unit circuitry 370, which includes data TLB unit circuitry 372 coupled to a data cache circuitry 374 coupled to a level 2 (L2) cache circuitry 376. In one exemplary embodiment, the memory access units circuitry 364 may include a load unit circuitry, a store address unit circuit, and a store data unit circuitry, each of which is coupled to the data TLB circuitry 372 in the memory unit circuitry 370. The instruction cache circuitry 334 is further coupled to a level 2 (L2) cache unit circuitry 376 in the memory unit circuitry 370. In one embodiment, the instruction cache 334 and the data cache 374 are combined into a single instruction and data cache (not shown) in L2 cache unit circuitry 376, a level 3 (L3) cache unit circuitry (not shown), and/or main memory. The L2 cache unit circuitry 376 is coupled to one or more other levels of cache and eventually to a main memory.

The core 390 may support one or more instructions sets (e.g., the x86 instruction set (with some extensions that have been added with newer versions); the MIPS instruction set; the ARM instruction set (with optional additional extensions such as NEON)), including the instruction(s) described herein. In one embodiment, the core 390 includes logic to support a packed data instruction set extension (e.g., AVX1, AVX2), thereby allowing the operations used by many multimedia applications to be performed using packed data.

### Exemplary Execution Unit(s) Circuitry

FIG. 4 illustrates embodiments of execution unit(s) circuitry, such as execution unit(s) circuitry 362 of FIG. 3(B). As illustrated, execution unit(s) circuitry 362 may include one or more ALU circuits 401, vector/SIMD unit circuits 403, load/store unit circuits 405, and/or branch/jump unit circuits 407. ALU circuits 401 perform integer arithmetic and/or Boolean operations. Vector/SIMD unit circuits 403 perform vector/SIMD operations on packed data (such as SIMD/vector registers). Load/store unit circuits 405 execute load and store instructions to load data from memory into registers or store from registers to memory. Load/store unit circuits 405 may also generate addresses. Branch/jump unit circuits 407 cause a branch or jump to a memory address depending on the instruction. Floating-point unit (FPU) circuits 409 perform floating-point arithmetic. The width of the execution unit(s) circuitry 362 varies depending upon the embodiment and can range from 16-bit to 1,024-bit. In some embodiments, two or more smaller execution units are logically combined to form a larger execution unit (e.g., two 128-bit execution units are logically combined to form a 256-bit execution unit).

### Exemplary Register Architecture

FIG. 5 is a block diagram of a register architecture 500 according to some embodiments. As illustrated, there are vector/SIMD registers 510 that vary from 128-bit to 1,024 bits width. In some embodiments, the vector/SIMD registers 510 are physically 512-bits and, depending upon the mapping, only some of the lower bits are used. For example, in some embodiments, the vector/SIMD registers 510 are ZMM registers which are 512 bits: the lower 256 bits are used for YMM registers and the lower 128 bits are used for XMM registers. As such, there is an overlay of registers. In some embodiments, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the embodiment.

In some embodiments, the register architecture 500 includes writemask/predicate registers 515. For example, in some embodiments, there are 8 writemask/predicate registers (sometimes called k0 through k7) that are each 16-bit, 32-bit, 64-bit, or 128-bit in size. Writemask/predicate registers 515 may allow for merging (e.g., allowing any set of elements in the destination to be protected from updates during the execution of any operation) and/or zeroing (e.g., zeroing vector masks allow any set of elements in the destination to be zeroed during the execution of any operation). In some embodiments, each data element position in a given writemask/predicate register 515 corresponds to a data element position of the destination. In other embodiments, the writemask/predicate registers 515 are scalable and consists of a set number of enable bits for a given vector element (e.g., 8 enable bits per 64-bit vector element).

The register architecture 500 includes a plurality of general-purpose registers 525. These registers may be 16-bit, 32-bit, 64-bit, etc. and can be used for scalar operations. In some embodiments, these registers are referenced by the names RAX, RBX, RCX, RDX, RBP, RSI, RDI, RSP, and R8 through R15.

In some embodiments, the register architecture 500 includes scalar floating-point register 545 which is used for scalar floating-point operations on 32/64/80-bit floating-point data using the x87 instruction set extension or as MMX registers to perform operations on 64-bit packed integer data, as well as to hold operands for some operations performed between the MMX and XMM registers.

One or more flag registers 540 (e.g., EFLAGS, RFLAGS, etc.) store status and control information for arithmetic, compare, and system operations. For example, the one or more flag registers 540 may store condition code information such as carry, parity, auxiliary carry, zero, sign, and overflow. In some embodiments, the one or more flag registers 540 are called program status and control registers.

Segment registers 520 contain segment points for use in accessing memory. In some embodiments, these registers are referenced by the names CS, DS, SS, ES, FS, and GS.

Machine specific registers (MSRs) 535 control and report on processor performance. Most MSRs 535 handle system-related functions and are not accessible to an application program. Machine check registers 560 consist of control, status, and error reporting MSRs that are used to detect and report on hardware errors.

One or more instruction pointer register(s) 530 store an instruction pointer value. Control register(s) 555 (e.g., CR0-CR4) determine the operating mode of a processor (e.g., processor 170, 180, 138, 115, and/or 200) and the characteristics of a currently executing task. Debug registers 550 control and allow for the monitoring of a processor or core's debugging operations.

Memory management registers 565 specify the locations of data structures used in protected mode memory management. These registers may include a GDTR, IDRT, task register, and a LDTR register.

Alternative embodiments of the invention may use wider or narrower registers. Additionally, alternative embodiments of the invention may use more, less, or different register files and registers.

### Instruction Sets

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

FIG. 6 illustrates embodiments of an instruction format. As illustrated, an instruction may include multiple components including, but not limited to, one or more fields for: one or more prefixes 601, an opcode 603, addressing information 605 (e.g., register identifiers, memory addressing information, etc.), a displacement value 607, and/or an immediate 609. Note that some instructions utilize some or all of the fields of the format whereas others may only use the field for the opcode 603. In some embodiments, the order illustrated is the order in which these fields are to be encoded, however, it should be appreciated that in other embodiments these fields may be encoded in a different order, combined, etc.

The prefix(es) field(s) 601, when used, modifies an instruction. In some embodiments, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 603 is used to at least partially define the operation to be performed upon a decoding of the instruction. In some embodiments, a primary opcode encoded in the opcode field 603 is 1, 2, or 3 bytes in length. In other embodiments, a primary opcode can be a different length. An additional 3-bit opcode field is sometimes encoded in another field.

The addressing field 605 is used to address one or more operands of the instruction, such as a location in memory or one or more registers. FIG. 7 illustrates embodiments of the addressing field 605. In this illustration, an optional ModR/M byte 702 and an optional Scale, Index, Base (SIB) byte 704 are shown. The ModR/M byte 702 and the SIB byte 704 are used to encode up to two operands of an instruction, each of which is a direct register or effective memory address. Note that each of these fields are optional in that not all instructions include one or more of these fields. The MOD R/M byte 702 includes a MOD field 742, a register field 744, and R/M field 746.

The content of the MOD field 742 distinguishes between memory access and non-memory access modes. In some embodiments, when the MOD field 742 has a value of b11, a register-direct addressing mode is utilized, and otherwise register-indirect addressing is used.

The register field 744 may encode either the destination register operand or a source register operand, or may encode an opcode extension and not be used to encode any instruction operand. The content of register index field 744, directly or through address generation, specifies the locations of a source or destination operand (either in a register or in memory). In some embodiments, the register field 744 is supplemented with an additional bit from a prefix (e.g., prefix 601) to allow for greater addressing.

The R/M field 746 may be used to encode an instruction operand that references a memory address, or may be used to encode either the destination register operand or a source register operand. Note the R/M field 746 may be combined with the MOD field 742 to dictate an addressing mode in some embodiments.

The SIB byte 704 includes a scale field 752, an index field 754, and a base field 756 to be used in the generation of an address. The scale field 752 indicates scaling factor. The index field 754 specifies an index register to use. In some embodiments, the index field 754 is supplemented with an additional bit from a prefix (e.g., prefix 601) to allow for greater addressing. The base field 756 specifies a base register to use. In some embodiments, the base field 756 is supplemented with an additional bit from a prefix (e.g., prefix 601) to allow for greater addressing. In practice, the content of the scale field 752 allows for the scaling of the content of the index field 754 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some embodiments, a displacement field 607 provides this value. Additionally, in some embodiments, a displacement factor usage is encoded in the MOD field of the addressing field 605 that indicates a compressed displacement scheme for which a displacement value is calculated by multiplying disp8 in conjunction with a scaling factor N that is determined based on the vector length, the value of a b bit, and the input element size of the instruction. The displacement value is stored in the displacement field 607.
In some embodiments, an immediate field 609 specifies an immediate for the instruction. An immediate may be encoded as a 1-byte value, a 2-byte value, a 4-byte value, etc.

FIG. 8 illustrates embodiments of a first prefix 601(A). In some embodiments, the first prefix 601(A) is an embodiment of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 601(A) may specify up to three registers using 3-bit fields depending on the format: 1) using the reg field 744 and the R/M field 746 of the Mod R/M byte 702; 2) using the Mod R/M byte 702 with the SIB byte 704 including using the reg field 744 and the base field 756 and index field 754; or 3) using the register field of an opcode.

In the first prefix 601(A), bit positions 7:4 are set as 0100. Bit position 3 (W) can be used to determine the operand size, but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 744 and MOD R/M R/M field 746 alone can each only address 8 registers.

In the first prefix 601(A), bit position 2 (R) may an extension of the MOD R/M reg field 744 and may be used to modify the ModR/M reg field 744 when that field encodes a general purpose register, a 64-bit packed data register (e.g., a SSE register), or a control or debug register. R is ignored when Mod R/M byte 702 specifies other registers or defines an extended opcode.

Bit position 1 (X) X bit may modify the SIB byte index field 754.

Bit position B (B) B may modify the base in the Mod R/M R/M field 746 or the SIB byte base field 756; or it may modify the opcode register field used for accessing general purpose registers (e.g., general purpose registers 525).

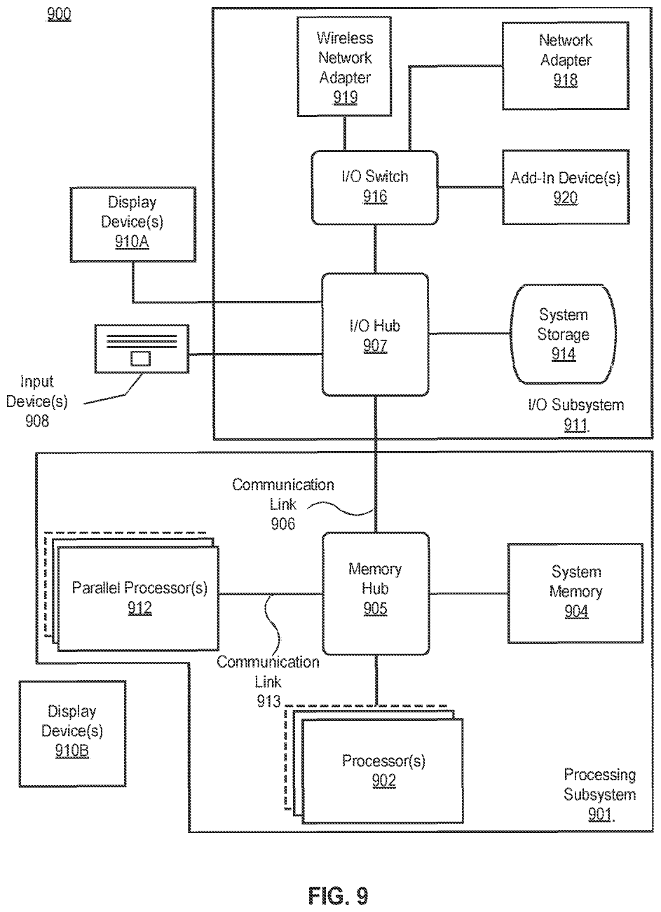

FIGS. 9(A)-(D) illustrate embodiments of how the R, X, and B fields of the first prefix 601(A) are used. FIG. 9(A) illustrates R and B from the first prefix 601(A) being used to extend the reg field 744 and R/M field 746 of the MOD R/M byte 702 when the SIB byte 704 is not used for memory addressing. FIG. 9(B) illustrates R and B from the first prefix 601(A) being used to extend the reg field 744 and R/M field 746 of the MOD R/M byte 702 when the SIB byte 704 is not used (register-register addressing). FIG. 9(C) illustrates R, X, and B from the first prefix 601(A) being used to extend the reg field 744 of the MOD R/M byte 702 and the index field 754 and base field 756 when the SIB byte 704 being used for memory addressing. FIG. 9(D) illustrates B from the first prefix 601(A) being used to extend the reg field 744 of the MOD R/M byte 702 when a register is encoded in the opcode 603.

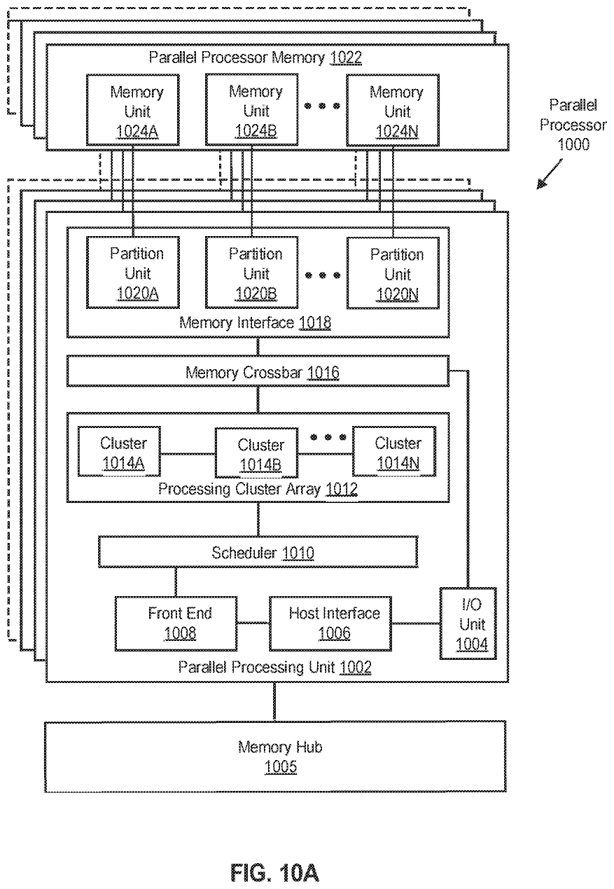

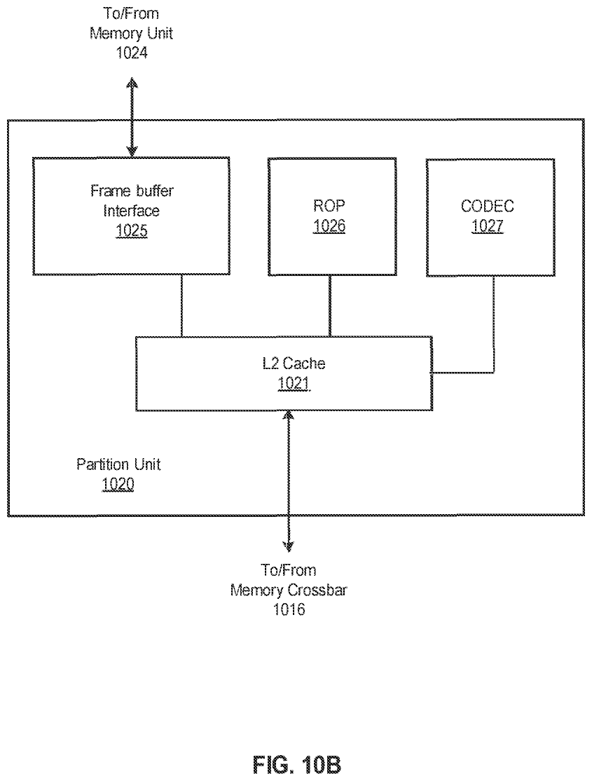

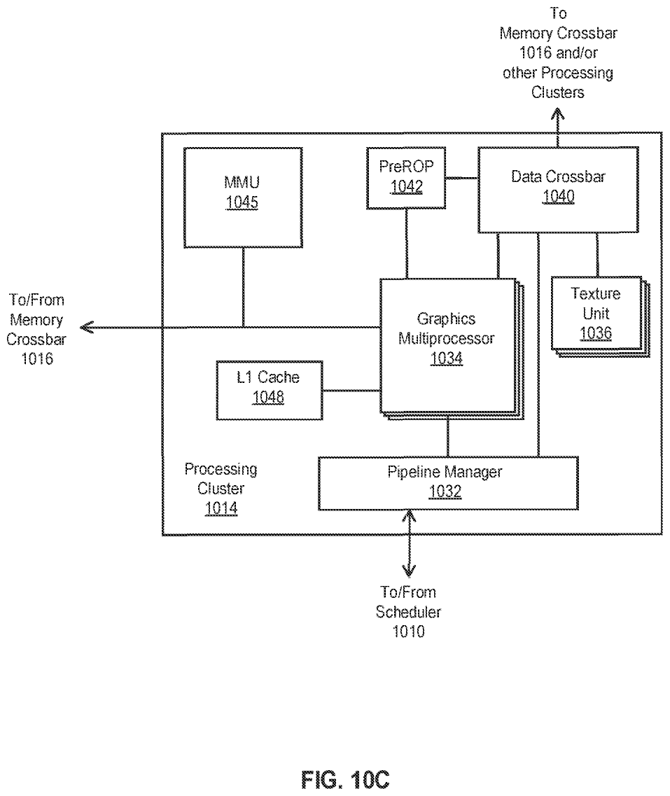

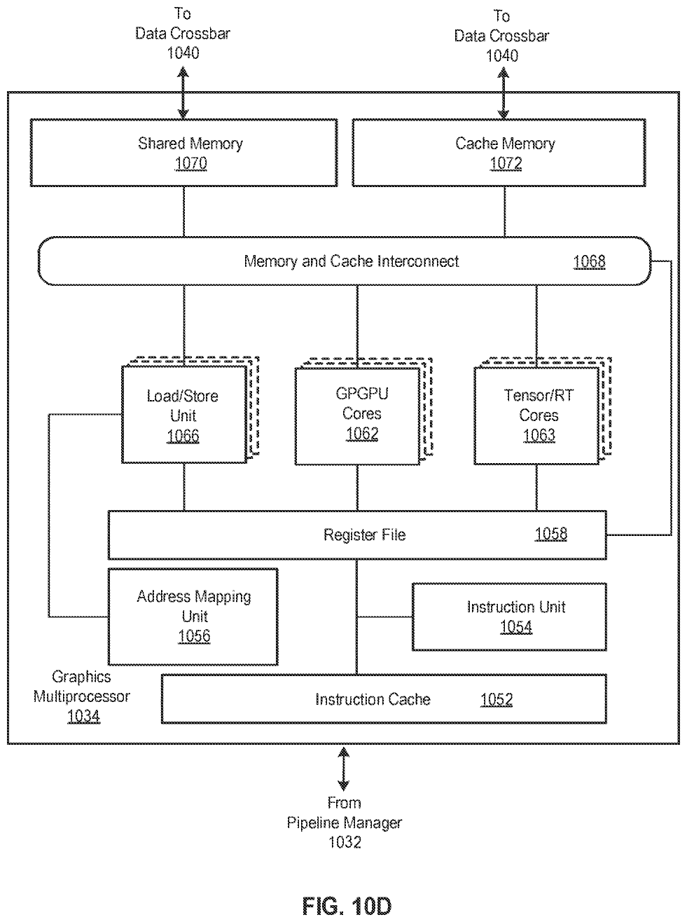

FIGS. 10(A)-(B) illustrate embodiments of a second prefix 601(B). In some embodiments, the second prefix 601(B) is an embodiment of a VEX prefix. The second prefix 601(B) encoding allows instructions to have more than two operands, and allows SIMD vector registers (e.g., vector/SIMD registers 510) to be longer than 64-bits (e.g., 128-bit and 256-bit). The use of the second prefix 601(B) provides for three-operand (or more) syntax. For example, previous two-operand instructions performed operations such as A=A+B, which overwrites a source operand. The use of the second prefix 601(B) enables operands to perform nondestructive operations such as A=B+C.

In some embodiments, the second prefix 601(B) comes in two forms—a two-byte form and a three-byte form. The two-byte second prefix 601(B) is used mainly for 128-bit, scalar, and some 256-bit instructions; while the three-byte second prefix 601(B) provides a compact replacement of the first prefix 601(A) and 3-byte opcode instructions.

FIG. 10(A) illustrates embodiments of a two-byte form of the second prefix 601(B). In one example, a format field 1001 (byte 0 1003) contains the value C5H. In one example, byte 1 1005 includes a “R” value in bit[7]. This value is the complement of the same value of the first prefix 601(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746 and the Mod R/M reg field 744 encode three of the four operands. Bits[7:4] of the immediate 609 are then used to encode the third source register operand.

FIG. 10(B) illustrates embodiments of a three-byte form of the second prefix 601(B). in one example, a format field 1011 (byte 0 1013) contains the value C4H. Byte 1 1015 includes in bits[7:5]“R,” “X,” and “B” which are the complements of the same values of the first prefix 601(A). Bits[4:0] of byte 1 1015 (shown as mmmmm) include content to encode, as need, one or more implied leading opcode bytes. For example, 00001 implies a 0FH leading opcode, 00010 implies a 0F38H leading opcode, 00011 implies a leading 0F3AH opcode, etc.

Bit[7] of byte 2 1017 is used similar to W of the first prefix 601(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 746 to encode the instruction operand that references a memory address or encode either the destination register operand or a source register operand.

Instructions that use this prefix may use the Mod R/M reg field 744 to encode either the destination register operand or a source register operand, be treated as an opcode extension and not used to encode any instruction operand.

For instruction syntax that support four operands, vvvv, the Mod R/M R/M field 746, and the Mod R/M reg field 744 encode three of the four operands. Bits[7:4] of the immediate 609 are then used to encode the third source register operand.

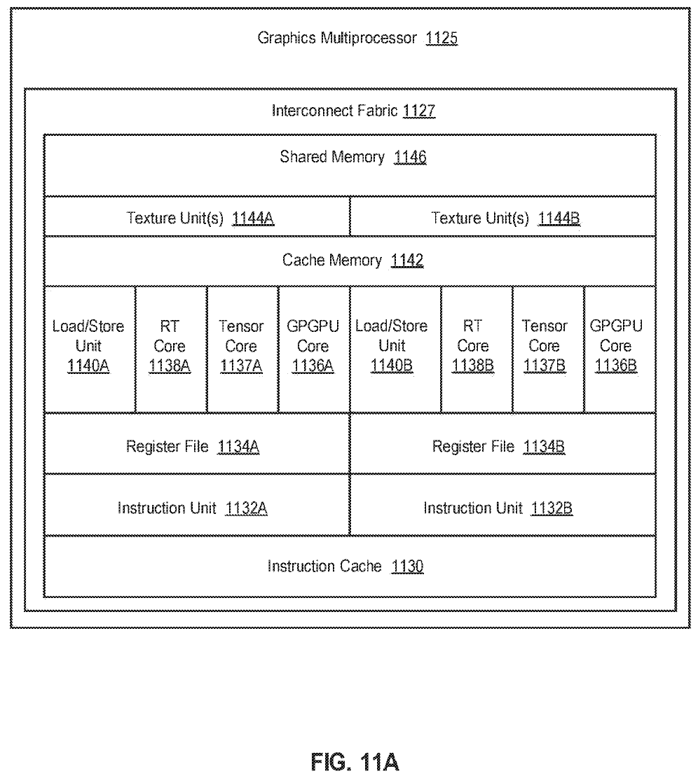

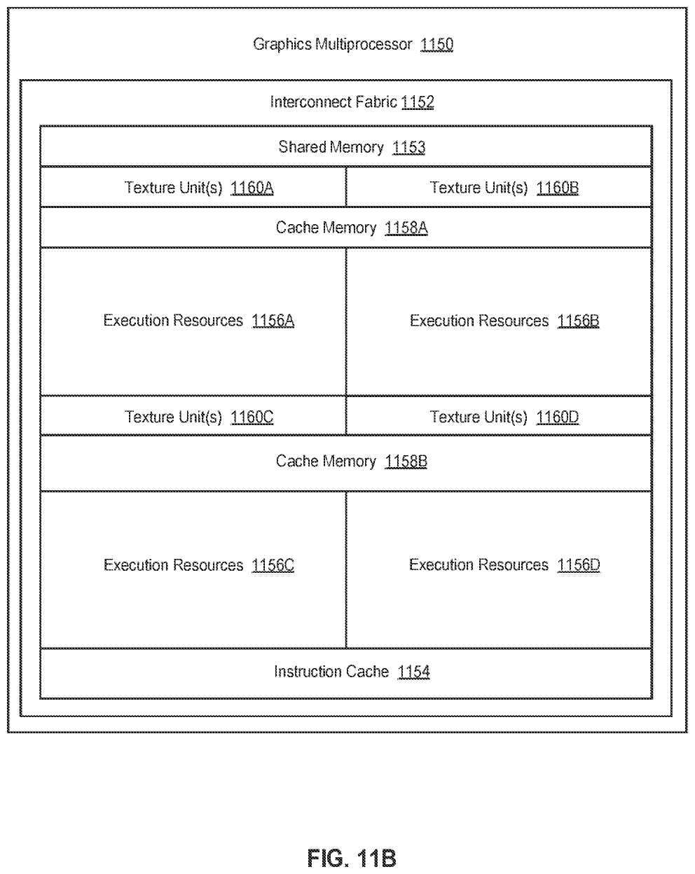

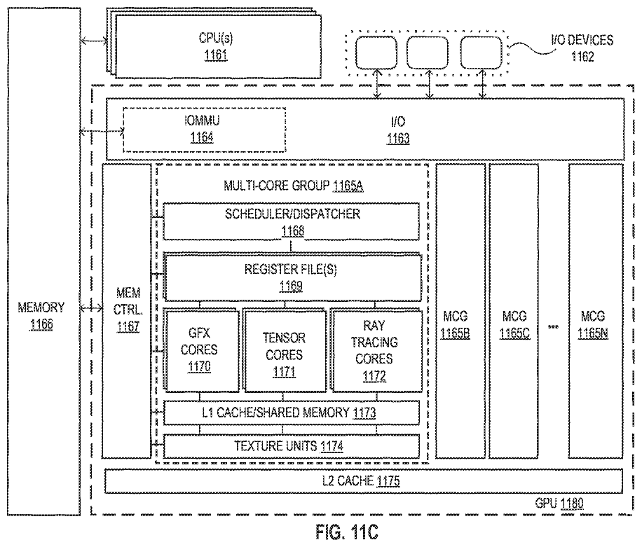

FIG. 11 illustrates embodiments of a third prefix 601(C). In some embodiments, the first prefix 601(A) is an embodiment of an EVEX prefix. The third prefix 601(C) is a four-byte prefix.

The third prefix 601(C) can encode 32 vector registers (e.g., 128-bit, 256-bit, and 512-bit registers) in 64-bit mode. In some embodiments, instructions that utilize a writemask/opmask (see discussion of registers in a previous figure, such as FIG. 5) or predication utilize this prefix. Opmask register allow for conditional processing or selection control. Opmask instructions, whose source/destination operands are opmask registers and treat the content of an opmask register as a single value, are encoded using the second prefix 601(B).

The third prefix 601(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 601(C) is a format field 1111 that has a value, in one example, of 62H. Subsequent bytes are referred to as payload bytes 1115-1119 and collectively form a 24-bit value of P[23:0] providing specific capability in the form of one or more fields (detailed herein).

In some embodiments, P[1:0] of payload byte 1119 are identical to the low two mmmmm bits. P[3:2] are reserved in some embodiments. Bit P[4](R′) allows access to the high 16 vector register set when combined with P[7] and the ModR/M reg field 744. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 744 and ModR/M R/M field 746. P[9:8] provide opcode extensionality equivalent to some legacy prefixes (e.g., 00=no prefix, 01=66H, 10=F3H, and 11=F2H). P[10] in some embodiments is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is similar to W of the first prefix 601(A) and second prefix 611(B) and may serve as an opcode extension bit or operand size promotion.

P[18:16] specify the index of a register in the opmask (writemask) registers (e.g., writemask/predicate registers 515). In one embodiment of the invention, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While embodiments of the invention are described in which the opmask field's content selects one of a number of opmask registers that contains the opmask to be used (and thus the opmask field's content indirectly identifies that masking to be performed), alternative embodiments instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary embodiments of encoding of registers in instructions using the third prefix 601(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, | Destination or Source |
| | | | reg | Vector | |
| VVVV | V′ | vvvv | | GPR, | 2nd Source or Destination |
| | | | | Vector | |
| RM | X | B | ModR/M | GPR, | 1st Source or Destination |
| | | | R/M | Vector | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2^{nd} Source or Destination |
| RM | ModR/M R/M | GPR, Vector | 1^{st} Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2^{nd} Source |
| RM | ModR/M R/M | k0-7 | 1^{st} Source |
| {k1] | aaa | k0¹-k7 | Opmask |

Program code may be applied to input instructions to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), or a microprocessor.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

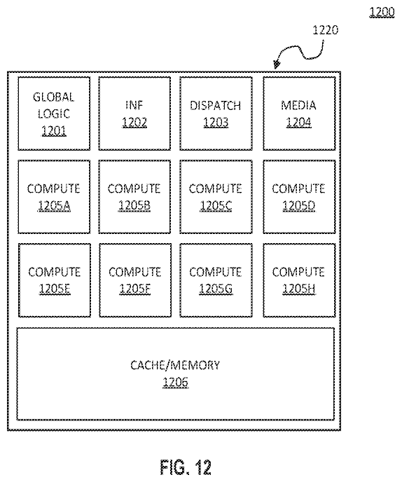

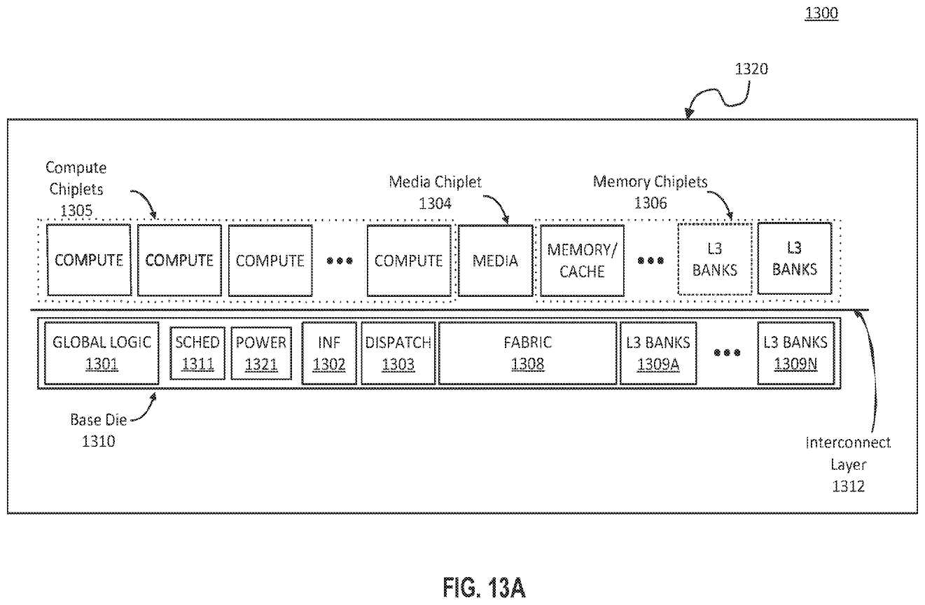

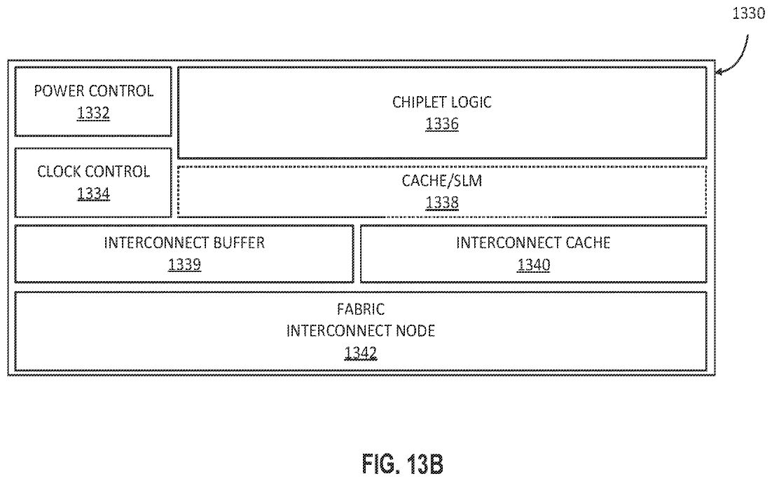

FIG. 12 illustrates a block diagram contrasting the use of a software instruction converter to convert binary instructions in a source instruction set to binary instructions in a target instruction set according to certain implementations. In the illustrated embodiment, the instruction converter is a software instruction converter, although alternatively the instruction converter may be implemented in software, firmware, hardware, or various combinations thereof. FIG. 12 shows a program in a high level language 1202 may be compiled using a first ISA compiler 1204 to generate first ISA binary code 1206 that may be natively executed by a processor with at least one first instruction set core 1216. The processor with at least one first ISA instruction set core 1216 represents any processor that can perform substantially the same functions as an Intel® processor with at least one first ISA instruction set core by compatibly executing or otherwise processing (1) a substantial portion of the instruction set of the first ISA instruction set core or (2) object code versions of applications or other software targeted to run on an Intel processor with at least one first ISA instruction set core, in order to achieve substantially the same result as a processor with at least one first ISA instruction set core. The first ISA compiler 1204 represents a compiler that is operable to generate first ISA a binary code 1206 (e.g., object code) that can, with or without additional linkage processing, be executed on the processor with at least one first ISA instruction set core 1216.

Similarly, FIG. 12 shows the program in the high level language 1202 may be compiled using an alternative instruction set compiler 1208 to generate alternative instruction set binary code 1210 that may be natively executed by a processor without a first ISA instruction set core 1214. The instruction converter 1212 is used to convert the first ISA binary code 1206 into code that may be natively executed by the processor without a first ISA instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have a first ISA instruction set processor or core to execute the first ISA binary code 1206.

### Apparatus and Method for Data Manipulation Detection or Replay Protection Based on Forced Encodings

There exist many standardized and non-standardized encryption techniques that do not expand plaintexts. Examples include the cipher-block chaining (CBC) mode, wide (tweakable) blockciphers and other Advanced Encryption Standard (AES)-based encryption techniques as used, for example, in current Total Memory Encryption-Multi-Key (TME-MK) implementations. These solutions offer data confidentiality but do not provide data manipulation detection or replay protection.

The techniques for data manipulation detection and replay protection described above with respect to FIGS. 1-6 can rely on collisions between bytes of the data contained in one cacheline which are used to encode the data. Some of these techniques rely on ambiguous encodings of data with repeated byte entries which allow for different choices of encodings, resulting in different ciphertexts when combined with encryption across repeated encryptions of the same plaintext. Some of these implementations apply rules to detect when the wrong pair was encoded, providing data integrity.

The encodings described herein can rely on look-up tables which are sufficiently small to be implemented in hardware as part of the same circuit/IP block. Note that the look-up tables used for these encodings are distinct from the “conflict table” previously described, which can generally be larger and stored in external DRAM, cache, or other memory device accessible to the processor cores. By way of example, and not limitation, if a look-up table is used for a single byte, then a partial encoding could be a look-up table in which, for some of the 256 entries, there is no mapping. For an ambiguous encoding, different entries in the look-up table may map to the same value.

Some implementations of the invention for performing data manipulation and replay protection build upon, and may be combined with, the techniques described with respect to FIGS. 1-6.

In some embodiments which implement (forced) table-based encoding, the look-up tables encode data using at least two classes of encodings. The first class of encodings is referred to as partial one-to-one encodings which only map a subset of the elements of its domain to distinct unique elements in its codomain. Such encodings are used to implement access control or manipulation detection of data in combination with a pure encryption scheme. Preferably, such encryption schemes provide full diffusion within the single elements. In operation, when a value is encountered during decryption that does not represent a one-to-one encoding, either the data has been manipulated or has been accessed with a wrong key.

The second class of encodings is referred to as partial ambiguous encodings. Like the partial one-to-one encodings, only a subset of the elements of the domain are mapped to the codomain. However, the mapping of a single element of the domain to the codomain is not unique, but ambiguous, meaning that the same element of the domain can map to several elements of the codomain, which are selected at random. Combining partial ambiguous encodings with an encryption scheme results in ambiguous ciphertexts, although the same plaintexts are encrypted.

Some implementations do not limit the encoding to either partial one-to-one encodings or partial ambiguous encodings. Rather, these implementations use a combination of these two encoding classes, for example, based on factors such as the characteristics of the data being encoded and the hardware capabilities of the processor.

In one implementation, for both the first and second group of encodings, a single exclusive value is reserved in the codomain as a conflict indicator which is used when data cannot be encoded. In some embodiments, the data which cannot be encoded is replaced with the conflict indicator value. The original data is then looked up in a conflict resolution table.

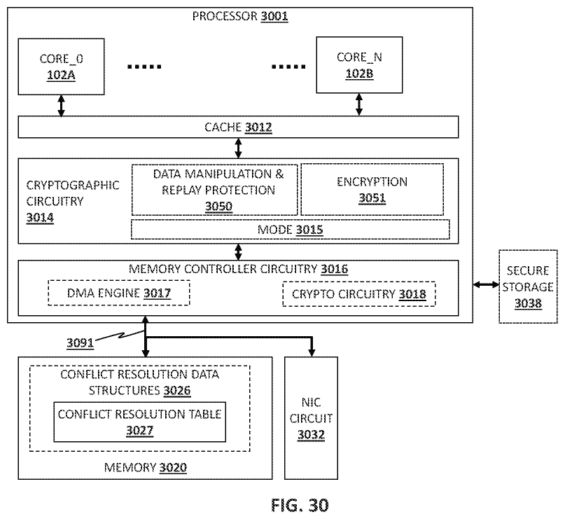

FIG. 30 illustrates a processor 3001 in accordance with embodiments of the invention which includes a plurality of cores 102A-B coupled to a shared cache 3012. Each core of the plurality of cores 102A-B may include instruction fetch circuitry, instruction decode circuitry, execution circuitry, and the various registers 110 described above with respect to core 102 illustrated in FIG. 1.

In certain examples, memory access (e.g., store or load) requests for memory 3020 are generated by a core 102A-B. In certain examples, a memory address for the memory access is generated by an address generation unit (AGU) of the execution circuitry. The memory access request may be serviced by a cache within a core 102A-B and/or the shared cache 3012. Additionally, or alternatively (e.g., for a cache miss), memory access request may be serviced by memory 3020 separate from a cache. The memory access requests generated by cores 102A-B may be load or store operations. A load operation reads data from the memory 3020 into a cache of a processor, e.g., cache 3012 and a store operation writes data to the memory 3020.

In certain examples, memory controller circuitry 3016 includes a direct memory access engine 3017, e.g., for performing accesses into memory 3020. Memory may be a volatile memory (e.g., DRAM), non-volatile memory (e.g., non-volatile DIMM or non-volatile DRAM) and/or secondary (e.g., external) memory (e.g., not directly accessible by a processor). In certain examples, memory controller circuitry 3017 is to perform compression and/or decompression of data, e.g., where multiple bits/bytes that are repeated in a data line are removed to allow for compression according to that repetition (e.g., repetition-based compression/decompression). Various other compression techniques may also be used.

In some embodiments, cryptographic circuitry 3014, 2018 is used by the plurality of cores 102A-B to perform cryptographic operations as described herein. As illustrated, the cryptographic circuitry 2018 may be integral to the memory control circuitry 3016 and/or the cryptographic circuitry 3014 may be coupled to the memory controller circuitry 3016 (e.g., coupled between the memory controller circuitry 3016 and the shared cache 3012 and/or between levels of the cache hierarchy).

In some embodiments, cryptographic circuitry 3014, 3018 is configurable to operate in a particular mode. For example, mode register 3015 shown in FIG. 30 may be a control register storing one or more mode control bits to configure the corresponding cryptographic circuitry 3014 in a particular operational mode (e.g., such as the partial one-to-one or partial ambiguous modes described herein). In some embodiments, one or more bits values may be updated in the mode register 3015 to indicate operation in accordance with the partial one-to-one encodings and partial ambiguous encodings described herein.

In some embodiments, the control registers and data registers of the cryptographic circuitry 3014, 3018 are only accessible by trusted software components. Thus, an application or virtual machine must request configuration changes via the virtual machine monitor and/or via firmware executed on a security processor.

In some implementations, the cryptographic circuitry 3012, 3018 may receive a memory access request from one or more of its cores 102A-B (e.g., a load or store operation) which includes an address, data to be encrypted (e.g., plaintext), and optionally a corresponding key (e.g., a key assigned to the hardware/software entity responsible for the request). For a store operation, the cryptographic circuitry 3012, 3018 may encrypt the data using the key to generate ciphertext (encrypted data) which is then stored to the memory 3020. For a load operation, the cryptographic circuitry 3012, 3018 may read a requested ciphertext from a specified address in the memory 3020 and decrypt the ciphertext using the key (or a different key).

Some embodiments of the cryptographic circuitry 3014 include data manipulation and replay protection circuitry 3050 for implementing the partial one-to-one and/or partial ambiguous encodings as described herein. In particular, the data manipulation & replay protection circuitry 3050 may encode repetitions within the data of one cacheline using these encodings. For partial one-to-one encodings, the data manipulation & replay protection circuitry 3050 only maps a subset of the elements of its domain to distinct unique elements in its codomain. For partial ambiguous encodings, the data manipulation & replay protection circuitry 3050 maps only a subset of the elements of the domain into the codomain. However, the mapping of a single element of the domain to the codomain is not unique, but ambiguous, meaning that the same element of the domain can map to several elements of the codomain, selected at random by the data manipulation & replay protection circuitry 3050.

In some embodiments, the cryptographic circuitry 3014 includes (tweakable) blockcipher circuitry 3051 to support encryption and decryption in accordance with a (tweakable) blockcipher-based encryption scheme as described herein. The (tweakable) blockcipher-based encryption scheme 3051 is configured to encrypt arbitrarily large strings of data where each bit of the ciphertext depends on each bit of the plaintext and vice-versa. Thus, when the plaintext changes, the ciphertext will appear completely random, even if a single bit is changed. Note, however, that this particular property is not required for complying with the underlying principles of the invention.

By way of example, and not limitation, the (tweakable) blockcipher-based encryption scheme of some embodiments utilizes a block size of 256-bits. The blockcipher is “tweakable”, meaning that it encrypts the message (e.g., a cacheline) under control of not only the encryption key but also a “tweak” to yield the ciphertext, which may be changed often (e.g., with each new cacheline encryption operation).

When used in combination with the partial one-to-one encodings, the tweakable blockcipher circuitry 3051 can be used for access control or manipulation detection of data. For example, when a value is encountered during decryption that does not represent a partial one-to-one encoding, it can be concluded that the data has been manipulated or has been accessed with a wrong key. Combining the partial ambiguous encodings with the (tweakable) blockcipher-based encryption scheme r 3051 results in ambiguous ciphertexts, although the same plaintexts are encrypted.

Some implementations of the data manipulation & replay protection circuitry 3050 do not limit the encoding to either partial one-to-one encodings or partial ambiguous encodings. Rather, these implementations use a combination of these two encoding classes. The choice between the two encodings may be made dynamically, for example, based on factors such as the characteristics of the data being encoded and the hardware capabilities of the processor.

In one implementation, for both the partial one-to-one and partial ambiguous encodings, a single exclusive value is reserved in the codomain as a conflict indicator which is used when data cannot be encoded, which may be one of the conflict resolution data structures 3026 stored in memory 3020. During encoding, the data manipulation & replay protection circuitry 3050 replaces the data which cannot be encoded with the conflict indicator value and stores the mapping in a conflict resolution table 3027. During decoding, the original data is then looked up in the conflict resolution table 3027.

As mentioned, an encryption scheme that provides full diffusion is used in some embodiments as an alternative to existing AES-based encryption techniques such as AES-XTS and AES-CBC. Note, however, that the cryptographic circuitry 3012, 3018 may support these AES-based encryption techniques as well as, or instead of an encryption scheme that provides full diffusion. In some implementations, one or more bits in the mode register 3015 may be programmed to indicate which of these different encryption modes are to be used.

Moreover, the partial one-to-one encodings, the partial ambiguous encoding, and tweakable blockcipher 3051 may be used in combination with the various memory encryption modes described herein including, but not limited to, total memory encryption (TME) and multi-key TME (TME-MK).

In certain examples, additional processor components, such as network interface circuitry (NIC) 3032, may rely on cryptographic circuitry 3014, 3018 to encrypt and decrypt data in memory 3020. Alternatively, or additionally, these components may include their own integrated cryptographic circuitry for performing at least some of the operations described herein (e.g., based on a cryptographic mode in use).

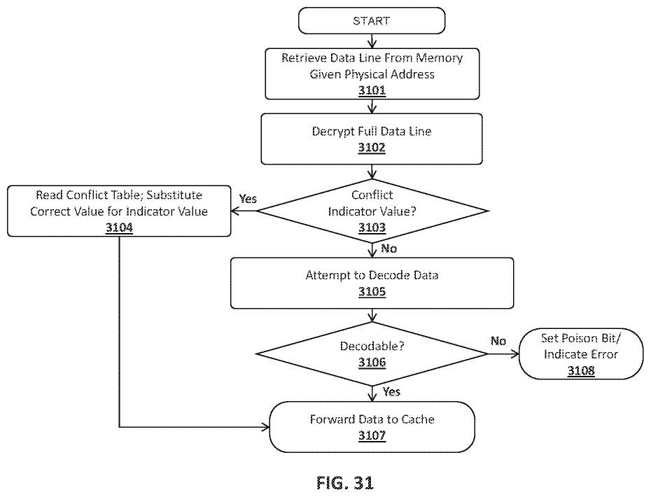

FIG. 31 illustrates a method for a memory read operation in accordance with embodiments of the invention. The method may be implemented within the context of the system architecture described herein, but is not limited to any particular processor or system architecture.

At 3101, a data line is retrieved from memory based on a physical address provided in a request (e.g., generated based on a load instruction executed by a core). At 3102, decryption of the full data line is initiated. If a conflict indicator value is detected in the data line, determined at 3103, then at 3104 the conflict table is read to identify the mapping between the indicator value and the correct value. The indicator value is replaced with the correct value from the conflict table and the data line is forwarded to the cache and/or the requestor at 3105.

If no conflict indicator value is detected at 3103, then the cryptographic engine attempts to decode the data line at 3105. If the data line is decodable, determined at 3106, then it is decoded to generate the unencrypted data line, which is forwarded to the cache/requestor at 3107. If the data line is not decodable, then at 3108 a poison bit is set to indicate an error and the data line is not decrypted. As mentioned, in this case, the data may have been manipulated or accessed with a wrong key.

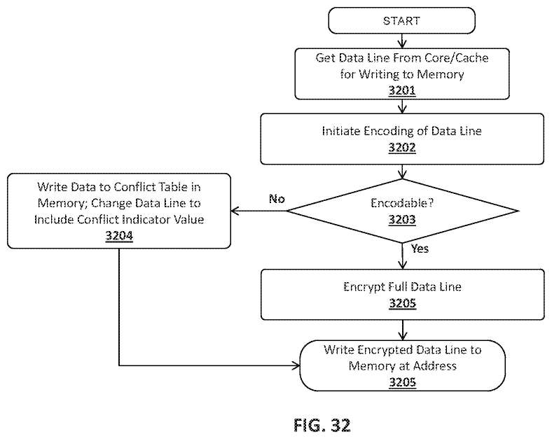

FIG. 32 illustrates a method for a memory store operation in accordance with embodiments of the invention. The method may be implemented within the context of the system architecture described herein, but is not limited to any particular processor or system architecture.

At 3201, the corresponding data line to be written to memory is received from a core or cache memory in response to a memory store instruction. At 3202, the encoding of the data line is initiated. If the data line is encodable, determined at 3203, then at 3205 the full data line is encrypted (e.g., using a tweakable blockcipher in one embodiment). At 3205, the encrypted data line is written to the physical address in memory indicated by the store operation.

If the data line is not encodable at 3203, then at 3204, the data (or portion thereof) is written to the conflict table in memory and the data line is modified to include the corresponding conflict indicator value (which can subsequently be used to perform a lookup in the conflict table to identify the original data). The data line containing the conflict indicator value is then written to the physical address in memory.

Encoding results performed with (A) partial ambiguous encoding, and (B) partial on-to-one encoding schemes in accordance with embodiments of the invention are shown directly below. These embodiments were tested on 64 bytes of random data, 64 bytes of structured data following a simple model mimicking natural language, and a Raw memory dump pulled from a freshly installed Ubuntu system. It can be seen from the results that the encodings are effective for all of the data input types, and particularly effective for the natural language model and the RAW data dump.

### (A) Partial Ambiguous Encoding

Encode 39th byte in 512 bits
Forced distribution
Partial Ambiguous Encoding
uint8_t encode [ ][ ] =
{{0,167,169,170,171,173,174,175,177,178,179,187,202,203},{1},
{2,205,206,207,211,212,214,215,217,218,220,225,227,228,234,241},{3},{4},{5},{6},{7},{8},{9},{10},{11},
{12},{13},{14},{15},{16},{17},{18},{19},{20},{21},{22},{23},{24},{25},{26},{27},{28},{29},{30},{31},{32},{33},
{34},{35},{36},{37},{38},{39},{40},{41},{42},{43},{44},{45},{46},{47},{48},{49},{50},{51},{52},{53},{54},{55},
{56},{57},{58},{59},{60},{61},{62},{63},{64},{65},{66},{67},{68},{69},{70},{71},{72},{73},{74},{75},{76},{77},
{78},{79},{80},{81},{82},{83},{84},{85},{86},{87},{88},{89},{90},{91},{92},{93},{94},{95},{96},{97},{98},{99},
{100},{101},{102},{103},{104},{105},{106},{107},{108},{109},{110},{111},{112},{113},{114},{115},{116},
{117},{118},{119},{120},{121},{122},{123},{124},{125},{126},{127},{128},{129},{130},{131},{132},{133},
{134},{135},{136},{137},{138},{139},{140},{141},{142},{143},{144},{145},{146},{147},{148},{149},{150},
{151},{152},{153},{154},{155},{156},{157},{158},{159},{160},{161},{162},{163},{164},{165},{ },{ },{168},{ },{ },
{ },{172},{ },{ },{ },{176},{ },{ },{ },{180},{181},{182},{183},{184},{185},{186},{ },{188},{189},{190},{191},{192},
{193},{194},{195},{196},{197},{198},{199},{200},{201},{ },{ },{204},{ },{ },{ },{208},{209},{210},{ },{ },{213},{ },{ },
{216},{ },{ },{219},{ },{221},{222},{223},{224},{ },{226},{ },{ },{229},{230},{231},{232},{233},{ },{235},{236},{237}
{238},{239},{240},{ },{242},{243},{244},{245},{246},{247},{248},{249},{250},{251},{252},{253},{254},{255}};
uint8_t decode =
{{0},{1},{2},{3},{4},{5},{6},{7},{8},{9},{10},{11},{12},{13},{14},{15},{16},{17},{18},{19},{20},{21},{22},{23},{24},
{25},{26},{27},{28},{29},{30},{31},{32},{33},{34},{35},{36},{37},{38},{39},{40},{41},{42},{43},{44},{45},{46},
{47},{48},{49},{50},{51},{52},{53},{54},{55},{56},{57},{58},{59},{60},{61},{62},{63},{64},{65},{66},{67},{68},
{69},{70},{71},{72},{73},{74},{75},{76},{77},{78},{79},{80},{81},{82},{83},{84},{85},{86},{87},{88},{89},{90},
{91},{92},{93},{94},{95},{96},{97},{98},{99},{100},{101},{102},{103},{104},{105},{106},{107},{108},{109},
{110},{111},{112},{113},{114},{115},{116},{117},{118},{119},{120},{121},{122},{123},{124},{125},{126},
{127},{128},{129},{130},{131},{132},{133},{134},{135},{136},{137},{138},{139},{140},{141},{142},{143},
{144},{145},{146},{147},{148},{149},{150},{151},{152},{153},{154},{155},{156},{157},{158},{159},{160},
{161},{162},{163},{164},{165},{ },{0},{168},{0},{0},{0},{172},{0},{0},{0},{176},{0},{0},{0},{180},{181},{182},
{183},{184},{185},{186},{0},{188},{189},{190},{191},{192},{193},{194},{195},{196},{197},{198},{199},{200}
{201},{0},{0},{204},{2},{2},{2},{208},{209},{210},{2},{2},{213},{2},{2},{216},{2},{2},{219},{2},{221},{222},
{223},{224},{2},{226},{2},{2},{229},{230},{231},{232},{233},{2},{235},{236},{237},{238},{239},{240},{2},
{242},{243},{244},{245},{246},{247},{248},{249},{250},{251},{252},{253},{254},{255}};
++++++++++++++++++++++++++++++++++++++++++++++++++++++
===================================================
Random data
Conflict indicator in plaintext
===================================================
Total iterations: 100000
Total encodable: 88794 => 88.794%
Average options: 1.12323
Statistics for wrong decryption
Detect misuse: 335 => 0.335%
Get encodable data: 99635 => 99.635%
Average options: 2.64428
Get non-encodable data: 30 => 0.03%
===================================================
Random data
Conflict indicator in ciphertext
===================================================
Total iterations: 1000000
Total encodable: 890254 => 89.0254%
Average options for encodable entries: 1.12187
Statistics for wrong decryption
Detect misuse: 109746 => 10.9746%
Get encodable data: 890254 => 89.0254%
Misuse average options for encodable entries: 2.64888
Get non-encodable data: 0 => 0%
===================================================
Simple natural language model
Conflict indicator in plaintext
===================================================
Total iterations: 100000
Total encodable: 100000 => 100%
Average options: 3.57152
Statistics for wrong decryption
Detect misuse: 390 => 0.39%
Get encodable data: 99610 => 99.61%
Average options: 2.67771
Get non-encodable data: 0 => 0%
===================================================
Simple natural language model
Conflict indicator in ciphertext
===================================================
Total iterations: 1000000
Total encodable: 1000000 => 100%
Average options for encodable entries: 3.57756
Statistics for wrong decryption
Detect misuse: 0 => 0%
Get encodable data: 1000000 => 100%
Misuse average options for encodable entries: 2.64755
Get non-encodable data: 0 => 0%
===================================================
RAM dump using clean_ubuntu_applications.txt
Conflict indicator in plaintext
===================================================
Total iterations: 58687488
Total encodable: 57945851 => 98.7363%
Average options: 7.635
Statistics for wrong decryption
Detect misuse: 226132 => 0.385316%
Get encodable data: 58458451 => 99.6097%
Average options: 2.65512
Get non-encodable data: 2905 => 0.00494995%
===================================================
RAM dump using clean_ubuntu_applications.txt
Conflict indicator in ciphertext
===================================================
Total iterations: 58687488
Total encodable: 57967876 => 98.7738%
Average options for encodable entries: 7.63248
Statistics for wrong decryption
Detect misuse: 719612 => 1.22618%
Get encodable data: 57967876 => 98.7738%
Misuse average options for encodable entries: 2.64795
Get non-encodable data: 0 => 0%
-----------------------------------------------------------

### (B) Partial One-to-One Encoding

Encode 39th byte in 512 bits
Forced distribution
Partial one-to-one encoding
uint8_t encode[ ][ ] =
{{0},{1},{2},{3},{4},{5},{6},{7},{8},{9},{10},{11},{12},{13},{14},{15},{16},{17},{18},{19},
{20},{21},{22},{23},{24},{25},{26},{27},{28},{29},{30},{31},{32},{33},{34},{35},{36},{37},{38},{39},{40},{41},
{42},{43},{44},{45},{46},{47},{48},{49},{50},{51},{52},{53},{54},{55},{56},{57},{58},{59},{60},{61},{62},{63},
{64},{65},{66},{67},{68},{69},{70},{71},{72},{73},{74},{75},{76},{77},{78},{79},{80},{81},{82},{83},{84},{85},
{86},{87},{88},{89},{90},{91},{92},{93},{94},{95},{96},{97},{98},{99},{100},{101},{102},{103},{104},{105},
{106},{107},{108},{109},{110},{111},{112},{113},{114},{115},{116},{117},{118},{119},{120},{121},{122},
{123},{124},{125},{126},{127},{128},{129},{130},{131},{132},{133},{134},{135},{136},{137},{138},{139},
{140},{141},{142},{143},{144},{145},{146},{147},{148},{149},{150},{151},{152},{153},{154},{155},{156},
{157},{158},{159},{160},{161},{162},{163},{164},{165},{ },{ },{168},{ },{ },{ },{172},{ },{ },{ },{176},{ },{ },{ },{180},
{181},{182},{183},{184},{185},{186},{ },{188},{189},{190},{191},{192},{193},{194},{195},{196},{197},{198},
{199},{200},{201},{ },{ },{204},{ },{ },{ },{208},{209},{210},{ },{ },{213},{ },{ },{216},{ },{ },{219},{ },{221},{222},{223},
{224},{ },{226},{ },{ },{229},{230},{231},{232},{233},{ },{235},{236},{237},{238},{239},{240},{ },{242},{243},
{244},{245},{246},{247},{248},{249},{250},{251},{252},{253},{254},{255}};
uint8_t decode[ ][ ] =
{{0},{1},{2},{3},{4},{5},{6},{7},{8},{9},{10},{11},{12},{13},{14},{15},{16},{17},{18},{19},
{20},{21},{22},{23},{24},{25},{26},{27},{28},{29},{30},{31},{32},{33},{34},{35},{36},{37},{38},{39},{40},{41},
{42},{43},{44},{45},{46},{47},{48},{49},{50},{51},{52},{53},{54},{55},{56},{57},{58},{59},{60},{61},{62},{63},
{64},{65},{66},{67},{68},{69},{70},{71},{72},{73},{74},{75},{76},{77},{78},{79},{80},{81},{82},{83},{84},{85},
{86},{87},{88},{89},{90},{91},{92},{93},{94},{95},{96},{97},{98},{99},{100},{101},{102},{103},{104},{105},
{106},{107},{108},{109},{110},{111},{112},{113},{114},{115},{116},{117},{118},{119},{120},{121},{122},
{123},{124},{125},{126},{127},{128},{129},{130},{131},{132},{133},{134},{135},{136},{137},{138},{139},
{140},{141},{142},{143},{144},{145},{146},{147},{148},{149},{150},{151},{152},{153},{154},{155},{156},
{157},{158},{159},{160},{161},{162},{163},{164},{165},{ },{ },{168},{ },{ },{ },{172},{ },{ },{ },{176},{ },{ },{ },{180},
{181},{182},{183},{184},{185},{186},{ },{188},{189},{190},{191},{192},{193},{194},{195},{196},{197},{198},
{199},{200},{201},{ },{ },{204},{ },{ },{ },{208},{209},{210},{ },{ },{213},{ },{ },{216},{ },{ },{219},{ },{221},{222},{223},
{224},{ },{226},{ },{ },{229},{230},{231},{232},{233},{ },{235},{236},{237},{238},{239},{240},{ },{242},{243},
{244},{245},{246},{247},{248},{249},{250},{251},{252},{253},{254},{255}};
++++++++++++++++++++++++++++++++++++++++++++++++++++++
===================================================
Random data
Conflict indicator in plaintext
===================================================
Total iterations: 100000
Total encodable: 88692 => 88.692%
Average options: 1
Statistics for wrong decryption
Detect misuse: 11223 => 11.223%
Get encodable data: 88734 => 88.734%
Average options: 1
Get non-encodable data: 43 => 0.043%
===================================================
Random data
Conflict indicator in ciphertext
===================================================
Total iterations: 1000000
Total encodable: 886968 => 88.6968%
Average options: 1
Statistics for wrong decryption
Detect misuse: 213169 => 21.3169%
Get encodable data: 786831 => 78.6831%
Average options: 1
Get non-encodable data: 0 => 0%
===================================================
Simple natural language model
Conflict indicator in plaintext
===================================================
Total iterations: 100000
Total encodable: 100000 => 100%
Average options: 1
Statistics for wrong decryption
Detect misuse: 11364 => 11.364%
Get encodable data: 88636 => 88.636%
Average options: 1
Get non-encodable data: 0 => 0%
===================================================
Simple natural language model
Conflict indicator in ciphertext
===================================================
Total iterations: 1000000
Total encodable: 1000000 => 100%
Average options: 1
Statistics for wrong decryption
Detect misuse: 113287 => 11.3287%
Get encodable data: 886713 => 88.6713%
Average options: 1
Get non-encodable data: 0 => 0%
===================================================
RAM dump using clean_ubuntu_applications.txt
Conflict indicator in plaintext
===================================================
Total iterations: 58687488
Total encodable: 57945851 => 98.7363%
Average options: 1
Statistics for wrong decryption
Detect misuse: 6640679 => 11.3153%
Get encodable data: 52043895 => 88.6797%
Average options: 1
Get non-encodable data: 2914 => 0.00496528%
===================================================
RAM dump using clean_ubuntu_applications.txt
Conflict indicator in ciphertext
===================================================
Total iterations: 58687488
Total encodable: 57945851 => 98.7363%
Average options: 1
Statistics for wrong decryption
Detect misuse: 7308016 => 12.4524%
Get encodable data: 51379472 => 87.5476%
Average options: 1
Get non-encodable data: 0 => 0%
-----------------------------------------------------------

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

### EXAMPLES

The following are example implementations of different embodiments of the invention.

Example 1. A processor, comprising: execution circuitry to execute instructions and generate memory access requests including load requests to read cachelines from memory and store requests to store cacheline to memory; and cryptographic circuitry to encrypt a cacheline and generate an encrypted cacheline responsive to a store request from a core of the plurality of cores, the encryption circuitry to map a subset of elements of the cacheline to corresponding elements in the encrypted cacheline and to encrypt the cacheline with a blockcipher encryption using a combination of a key and a tweak value.

Example 2. The processor of example 1 wherein each corresponding element comprises a distinct unique element in the encrypted cacheline.

Example 3. The processor of examples 1 or 2 wherein at least one element of the subset of elements of the cacheline maps to multiple corresponding elements in the encrypted cacheline.

Example 4. The processor of any of examples 1-3 wherein if at least one element of the cacheline is not encodable, the cryptographic circuitry is to replace the at least one element with a conflict indicator value and to store a mapping between the conflict indicator value and the at least one element in a conflict data structure.

Example 5. The processor of any of examples 1-4 wherein the conflict data structure comprise a conflict resolution table stored in a memory.

Example 6. The processor of any of examples 1-5 wherein in response to a load request for the encrypted cacheline, the cryptographic circuitry is to decrypt the encrypted cacheline using the key and the tweak value.

Example 7. The processor of any of examples 1-6 wherein to decrypt the encrypted cacheline, the cryptographic circuitry is to read the conflict data structure to identify the conflict indicator value and to replace the conflict indicator value with the at least one element of the cacheline.

Example 8. The processor of any of examples 1-7, further comprising: a plurality of cores, the execution circuitry integral to a core of the plurality of cores, wherein the cryptographic circuitry is shared by the plurality of cores.

Example 9. The processor of any of examples 1-8, further comprising: a plurality of cores, wherein the execution circuitry and the cryptographic circuitry are integral to a first core of the plurality of cores, and wherein one or more additional cores of the plurality of cores include one or more additional instances of the execution circuitry and the cryptographic circuitry.

Example 10. A method, comprising: generating memory access requests in response to instructions, the memory access requests including load requests to read cachelines from memory and store requests to store cacheline to memory; and generating an encrypted cacheline responsive to a store request from a core of the plurality of cores by performing operations including: mapping a subset of elements of a cacheline to corresponding elements in the encrypted cacheline; and encrypting the cacheline with a blockcipher encryption using a combination of a key and a tweak value.

Example 11. The method of example 10 wherein each corresponding element comprises a distinct unique element in the encrypted cacheline.

Example 12. The method of examples 10 or 11 wherein at least one element of the subset of elements of the cacheline maps to multiple corresponding elements in the encrypted cacheline.

Example 13. The method of any of examples 10-13 wherein if at least one element of the cacheline is not encodable, then replacing the at least one element with a conflict indicator value and to storing a mapping between the conflict indicator value and the at least one element in a conflict data structure.

Example 14. The method of any of examples 10-13 wherein the conflict data structure comprise a conflict resolution table stored in a memory.

Example 15. The method of any of examples 10-14 wherein in response to a load request for the encrypted cacheline, decrypting the encrypted cacheline using the key and the tweak value.

Example 16. The method of any of examples 10-15 wherein to decrypt the encrypted cacheline, reading the conflict data structure to identify the conflict indicator value and replacing the conflict indicator value with the at least one element of the cacheline.

Example 17. A machine-readable medium having program code stored thereon which, when executed by a machine, causes the machine to perform operations, comprising: generating memory access requests in response to instructions, the memory access requests including load requests to read cachelines from memory and store requests to store cacheline to memory; and generating an encrypted cacheline responsive to a store request from a core of the plurality of cores by performing operations including: mapping a subset of elements of a cacheline to corresponding elements in the encrypted cacheline; and encrypting the cacheline with a blockcipher encryption using a combination of a key and a tweak value.

Example 18. The method of example 17 wherein each corresponding element comprises a distinct unique element in the encrypted cacheline.

Example 19. The method of examples 17 or 18 wherein at least one element of the subset of elements of the cacheline maps to multiple corresponding elements in the encrypted cacheline.

Example 20. The method of any of examples 17-19 wherein if at least one element of the cacheline is not encodable, then replacing the at least one element with a conflict indicator value and to storing a mapping between the conflict indicator value and the at least one element in a conflict data structure.

Example 21. The method of any of examples 16-20 wherein the conflict data structure comprise a conflict resolution table stored in a memory.

Example 22. The method of any of examples 16-21 wherein in response to a load request for the encrypted cacheline, decrypting the encrypted cacheline using the key and the tweak value.

Example 23. The method of any of examples 16-22 wherein to decrypt the encrypted cacheline, reading the conflict data structure to identify the conflict indicator value and replacing the conflict indicator value with the at least one element of the cacheline.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
execution circuitry to execute instructions and generate memory access requests including load requests to read cachelines from memory and store requests to store cachelines to memory; and
cryptographic circuitry to encrypt a cacheline in order to generate an encrypted cacheline, responsive to a store request, the cryptographic circuitry to map a subset of elements of the cacheline to corresponding elements in the encrypted cacheline and to encrypt the cacheline with a blockcipher encryption using a combination of a key and a tweak value.

2. The processor of claim 1 wherein each corresponding element comprises a distinct unique element in the encrypted cacheline.

3. The processor of claim 1 wherein at least one element of the subset of elements of the cacheline maps to multiple corresponding elements in the encrypted cacheline.

4. The processor of claim 1 wherein if at least one element of the cacheline is not encodable, the cryptographic circuitry is to replace the at least one element with a conflict indicator value and to store a mapping between the conflict indicator value and the at least one element in a conflict data structure.

5. The processor of claim 4 wherein the conflict data structure comprise a conflict resolution table stored in a memory.

6. The processor of claim 4 wherein in response to a load request for the encrypted cacheline, the cryptographic circuitry is to decrypt the encrypted cacheline using the key and the tweak value.

7. The processor of claim 6 wherein to decrypt the encrypted cacheline, the cryptographic circuitry is to read the conflict data structure to identify the conflict indicator value and to replace the conflict indicator value with the at least one element of the cacheline.

8. The processor of claim 1, further comprising: a plurality of cores, the execution circuitry integral to a core of the plurality of cores, wherein the cryptographic circuitry is shared by the plurality of cores.

9. The processor of claim 1, further comprising: a plurality of cores, wherein the execution circuitry and the cryptographic circuitry are integral to a first core of the plurality of cores, and wherein one or more additional cores of the plurality of cores include one or more additional instances of the execution circuitry and the cryptographic circuitry.

10. A method, comprising:
generating memory access requests in response to instructions, the memory access requests including load requests to read cachelines from memory and store requests to store cachelines to memory; and
generating an encrypted cacheline responsive to a store request by performing operations including:
mapping a subset of elements of the cacheline to corresponding elements in the encrypted cacheline; and
encrypting the cacheline with a blockcipher encryption using a combination of a key and a tweak value.

11. The method of claim 10 wherein each corresponding element comprises a distinct unique element in the encrypted cacheline.

12. The method of claim 10 wherein at least one element of the subset of elements of the cacheline maps to multiple corresponding elements in the encrypted cacheline.

13. The method of claim 10 wherein if at least one element of the cacheline is not encodable, then replacing the at least one element with a conflict indicator value and to storing a mapping between the conflict indicator value and the at least one element in a conflict data structure.

14. The method of claim 13 wherein the conflict data structure comprise a conflict resolution table stored in a memory.

15. The method of claim 13 wherein in response to a load request for the encrypted cacheline, decrypting the encrypted cacheline using the key and the tweak value.

16. The method of claim 15 wherein to decrypt the encrypted cacheline, reading the conflict data structure to identify the conflict indicator value and replacing the conflict indicator value with the at least one element of the cacheline.

17. A machine-readable medium having program code stored thereon which, when executed by a machine, causes the machine to perform operations, comprising:
generating memory access requests in response to instructions, the memory access requests including load requests to read cachelines from memory and store requests to store cacheline to memory; and
generating an encrypted cacheline responsive to a store request from a core of the plurality of cores by performing operations including:
mapping a subset of elements of a cacheline to corresponding elements in the encrypted cacheline; and
encrypting the cacheline with a blockcipher encryption using a combination of a key and a tweak value.

18. The machine-readable medium of claim 17 wherein each corresponding element comprises a distinct unique element in the encrypted cacheline.

19. The machine-readable medium of claim 17 wherein at least one element of the subset of elements of the cacheline maps to multiple corresponding elements in the encrypted cacheline.

20. The machine-readable medium of claim 17 wherein if at least one element of the cacheline is not encodable, then replacing the at least one element with a conflict indicator value and to storing a mapping between the conflict indicator value and the at least one element in a conflict data structure.
